(19) United States
(12) Patent Application Publication
(10) Pub. No.: US 2025/0259541 A1
(43) Pub. Date: Aug. 14, 2025

(54) FORMING NETWORK LOOPS FOR IMPROVED KNOWLEDGE COMPOSITION

(71) Applicant: TOYOTA MOTOR ENGINEERING & MANUFACTURING NORTH AMERICA, INC., Plano, TX (US)

(72) Inventors: SEYHAN UCAR, Mountain View, CA (US); Onur Altintas, Mountain View, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, TOYOTA-SHI (JP)

(21) Appl. No.: 18/437,768

(22) Filed: Feb. 9, 2024

(51) Int. Cl. G08G 1/0967; G08G 1/01; H04W 4/46

(52) U.S. Cl. CPC G08G 1/096725; G08G 1/0112; G08G 1/0129; G08G 1/0141; G08G 1/096791; H04W 4/46

(57) ABSTRACT

Systems and methods are provided forming context-based communication paths through a vehicular knowledge network that provide improved knowledge refinement. Examples include obtaining a plurality of contextual features of a driving environment based on knowledge related to the driving environment obtained using sensor data collected by a first vehicle in the driving environment, and identifying a plurality of nodes of a vehicular knowledge network based on the plurality of contextual features. Each of the plurality of nodes may comprise node knowledge associated with a respective subset of the plurality of contextual features. The example also include generating merged knowledge by combining the first knowledge with the node knowledge of at least one of the plurality of nodes, and transmitting the merged knowledge to a second vehicle. The second vehicle can perform a vehicular operation based on the merged knowledge.

### REFERENCE TO RELATED APPLICATIONS

The present application is related to U.S. patent application Ser. No. 16/365,092, filed Mar. 26, 2019, and titled “VEHICULAR KNOWLEDGE DISTRIBUTION SYSTEM;” U.S. patent application Ser. No. 16/735,612, filed Jan. 6, 2020, and titled “VEHICULAR MICRO CLOUD HUBS;” U.S. patent application Ser. No. 18/173,524, filed Feb. 23, 2023, and titled “SYSTEMS AND METHODS TO IMPROVE KNOWLEDGE CYCLES IN VEHICULAR KNOWLEDGE NETWORKING;” U.S. patent application Ser. No. 18/300,367, filed Apr. 13, 2023, and titled “SYSTEMS AND METHODS FOR CONTEXT BASED KNOWLEDGE FORWARDING IN VEHICULAR KNOWLEDGE NETWORKING,” which are incorporated herein by reference in entirety.

### TECHNICAL FIELD

The present disclosure relates generally to systems and methods for vehicular knowledge networking, and, more particularly, some embodiments relate to an improving knowledge refinement in vehicular knowledge networking by forming context-based communication paths through a vehicular knowledge network.

### DESCRIPTION OF RELATED ART

Technological advancements in the realm of communication networking have led to an emergence of “vehicular networking” (or connected vehicles), where direct connections between vehicles and other points (e.g., infrastructure, network, cloud, etc.) are enabled. With the various types of vehicle communication capabilities that have become available, vehicular networking may be further leveraged to support the concept of sharing “knowledge” in a manner that improves the operation of vehicles.

Occasionally, driving scenarios exist where driver's do not know how to behave. For example, a driver may not understand how to safely perform a merge maneuver with a plurality of vehicles all traveling uniformly in the same lane. A driver may also not know how to proceed through an atypical intersection. Not knowing how to behave in these scenarios can result in accidents. In instances such as these, equipping vehicles with the capability to analyze, store, and share knowledge (e.g., knowledge of how to maneuver safely in certain situations) is promising and can improve vehicle safety and overall performance.

### BRIEF SUMMARY OF THE DISCLOSURE

According to various embodiments of the disclosed technology, systems and methods for managing vehicles to mitigate risk to the vehicles due to anomalous driving behavior are provided.

In accordance with some embodiments, a method is provided. The method comprises obtaining a plurality of contextual features of a driving environment based on knowledge related to the driving environment obtained using sensor data collected by a first vehicle in the driving environment, and identifying a plurality of nodes of a vehicular knowledge network based on the plurality of contextual features. Each of the plurality of nodes may comprise node knowledge associated with a respective subset of the plurality of contextual features. The method also comprises generating merged knowledge by combining the first knowledge with the node knowledge of at least one of the plurality of nodes, and transmitting the merged knowledge to a second vehicle. The second vehicle can perform a vehicular operation based on the merged knowledge.

In another aspect, a vehicle is provided that comprises a memory storing instructions and one or more processors communicably coupled to the memory. The one or more processors are configured to execute the instructions derive a plurality of contextual features of a driving environment based on sensor data collected by a first vehicle in the driving environment, the plurality of contextual features are associated with first knowledge related to the driving environment, and establish a communication path through a vehicular knowledge network based on the plurality of contextual features. The path may comprise a plurality of nodes, and at least one of the plurality of nodes comprises node knowledge associated with at least one of the plurality of contextual features. The one or more processors are further configured to execute the instructions to receive merged knowledge based on combining the first knowledge with the knowledge of each of the plurality of nodes. Vehicular operations may be performed based on the merged knowledge.

In another aspect, system is provided that comprises a memory storing instructions and one or more processors communicably coupled to the memory. The one or more processors are configured to execute the instructions receive, from a vehicle, a plurality of contextual features associated with knowledge related to a driving environment based on sensor data of the vehicle collected from the driving environment, and execute cycle detection to identify a communication path through a plurality of nodes of vehicular knowledge network. Each of the plurality of nodes may comprise at least a contextual feature of the plurality of contextual features, and the plurality of nodes may collectively comprise the plurality of contextual features. The one or more processors are further configured to execute the instructions execute knowledge composition to generate merged knowledge by aggregating node knowledge of the plurality of nodes with the knowledge.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic diagram of an example vehicular knowledge network system in accordance with embodiments disclosed herein.

FIG. 2 depicts a conceptual diagram for a hierarchal architecture for data, information, and knowledge used in a vehicular knowledge network, for example the vehicular knowledge network of FIGS. 1 in accordance with embodiments disclosed herein.

FIG. 3 is a schematic representation of an example hybrid vehicle with which embodiments of the systems and methods disclosed herein may be implemented.

FIG. 4 illustrates an example architecture for vehicular assisted hierarchical federated learning in accordance with one embodiment of the systems and methods described herein.

FIG. 5 is a flow chart illustrating example operations for context-based knowledge refinement in vehicular knowledge networking in accordance with embodiments disclosed herein.

FIGS. 6A and 6B depict examples of different context-based communication paths that can be formed through the vehicular knowledge network system of FIG. 1 in accordance with embodiments disclosed herein.

FIGS. 7A-7C depict an example illustration of a use case of embodiments disclosed herein including context-based knowledge refinement.

FIG. 8 is a flow chart illustrating an example process of context-based knowledge refinement in accordance with embodiments disclosed herein.

FIG. 9 is an example computing component that may be used to implement various features of embodiments described in the present disclosure.

The figures are not exhaustive and do not limit the present disclosure to the precise form disclosed.

### DETAILED DESCRIPTION

On occasion, in certain complicated driving environments that may be confusing to the driver, a driver may not know how to behave or may behave in a manner that is risky and increases the potential of a dangerous accident (or collision). A driver's behavior can refer generally to actions, reactions, omissions, or operations that may be performed or undertaken by a driver while operating a vehicle. At certain times while operating a vehicle, traffic conditions, environmental conditions, or the vehicle's condition and/or operating state may cause or result in a driver not knowing or understanding what action, reaction, operation, or driving decision, should be performed upon encountering such a condition. For example, when a driver enters into a roundabout, or when a driver is attempting to merge into a lane with a platoon of vehicles (i.e., a series of vehicles traveling at roughly the same speed in the same lane at roughly the same intervals), the driver may not fully appreciate the right-of-way rules associated with, or might not be adept at handling, the roadway or the traffic pattern. Another such example is when a driver misses their intended exit, and as a result may be confused as to whether they should refrain from performing any risky driving maneuvers (e.g., keep going and eventually loop back around) which then causes them to have to reroute. However, in this scenario, some drivers decide to engage in risky behavior in attempt to reach the correct exit, such as perform abrupt lane changes or slam on the brakes, hoping they can still make the turn. In order to address the aforementioned and similar issues, equipping vehicles with capabilities to infer and share guidance in instances when many drivers become confused in these complicated driving environments (referred to herein as risky zone) may mitigate collision risk in these zones, thereby preventing vehicular damage, bodily injury and/or fatality, and significantly improving overall driver safety.

Current methods to improve vehicle safety typically include providing feedback as the driver engages in an unsafe driving maneuver. For example, a current driver/vehicle safety system may produce an audible notification to warn the driver that they are attempting to move into a lane that is already occupied by another vehicle. Particularly, a current driver/vehicle safety system may beep if a driver attempts to change lanes and does not see another vehicle in his/her blind spot, in order to notify the driver of the vehicle in his/her blind spot. Although such safety alerts can be helpful, current driver/vehicle safety systems are well equipped to identify dangerous systems in advance (e.g., providing little to no reaction time), which increases the risk of a catastrophic collision. In other words, these conventional driver/vehicle safety systems do not proactively provide guidance and/or knowledge that the driver can utilize while they are still approaching a risky zone. Although reactive feedback methods offer some level of prevention, a predictive system and method could prevent the drivers from engaging in the unsafe driving maneuver altogether.

In contrast to the aforementioned conventional systems, embodiments of the disclosed system distinctly leverage communicating “knowledge” among vehicles and infrastructure elements (also referred to herein a vehicular knowledge networking) in a manner that proactively warns drivers in risky zones (e.g., risky and/or confusing driving environments). For instance, embodiments of the disclosed system may employ vehicular networking capabilities, such as vehicle-to-vehicle or vehicle-to-infrastructure (V2X) communication, to create and distribute contextual knowledge of risky zones. Further, this knowledge can be received by a vehicle (e.g., a driver approaching said risky zone) as early guidance, allowing the driver to be preemptively prepared before entering the risky zone and then safely maneuver once driving inside of the zone. This guidance, which may be referred to as knowledge-based guidance, can be executed autonomously and/or semi-autonomously depending on the application and vehicle systems implemented. For example, the knowledge can be utilized by trained machine learning models to generate the knowledge-based guidance. Because it is so crucial to stay alert and aware of complicated driving environments, like risky zones, while driving, the disclosed embodiments may utilize vehicular knowledge networking to implement a more effective safety system that equips vehicles to provide a priori guidance (e.g., prior to entering the risky zone) in a manner that thwarts driver confusion and enables the driver to be ready for maneuvering safely before reaching the risky zone. Restated, the vehicular knowledge network system and methods proposed herein, leverage knowledge to assist drivers in various driver/vehicle safety applications, such as risk reasoning and vehicular maneuvering in a manner that is preemptive and provides improvements over the reactionary (i.e., systems based on the driver engaging, or attempting to engage in a driving maneuver) limitations of conventional driver/vehicle safety systems.

Furthermore, the disclosed embodiments provide for context-based knowledge refinement that forms communication paths through vehicular knowledge network based a context associated with the knowledge. Embodiments disclosed herein improve on knowledge refinement by combining different knowledge, specific to different context, from nodes of the vehicular knowledge network to generate merged knowledge. The merged knowledge optimizes benefits of knowledge-based guidance implemented therefrom due to combining knowledge across a more diverse distribution of raw data from which the knowledge is generated. A vehicular knowledge network, which can be used to perform vehicular knowledge networking, can comprise a plurality of vehicular knowledge networking nodes that are communicably connected to each other. As used herein, a “vehicular knowledge networking node” or “node” refers to an entity or device of the vehicular knowledge network. In various examples disclosed herein, a node may be, but is not limited to, a vehicle, a remote server (e.g., an edge server, a centralized cloud server, and the like), roadside equipment (RSE) of a roadside infrastructure, and the like.

As described herein, a context is related to circumstances, descriptors, and situational characteristics for an event and/or location (e.g., driving environment) in terms that allow the environment to be understood and assessed by a computation system. With respect to vehicular knowledge networking, a “context” can be formed from several characteristics that describe aspects or conditions of the driving environment, such as road geometry, traffic flow, and the like, which are linked to a time when the knowledge was initially created. For example, knowledge of a complicated driving environment may be created using raw data obtained from vehicles experiencing clear weather conditions while traveling in a given driving environment. This knowledge can be utilized by trained machine learning models to generate knowledge-based guidance, which can be provided to vehicles traveling in this environment. However, it may be detrimental if a vehicle currently driving in that same location, but in rainy weather conditions, attempts to apply that knowledge (having a “clear weather” context) for its driving environment analysis. If knowledge is utilized in the wrong context, even when it is the “correct” knowledge (e.g., knowledge for the right location and/or event), the knowledge's accuracy may be undermined in a manner that negatively affects the vehicle's functions, for instance, leading to the vehicle making contrasting decisions relative to the knowledge, which impacts the overall driver/vehicle safety. In other words, the accuracy and usefulness of knowledge can be weakened when the knowledge is applied in a context that is dissimilar to the context in which it was created.

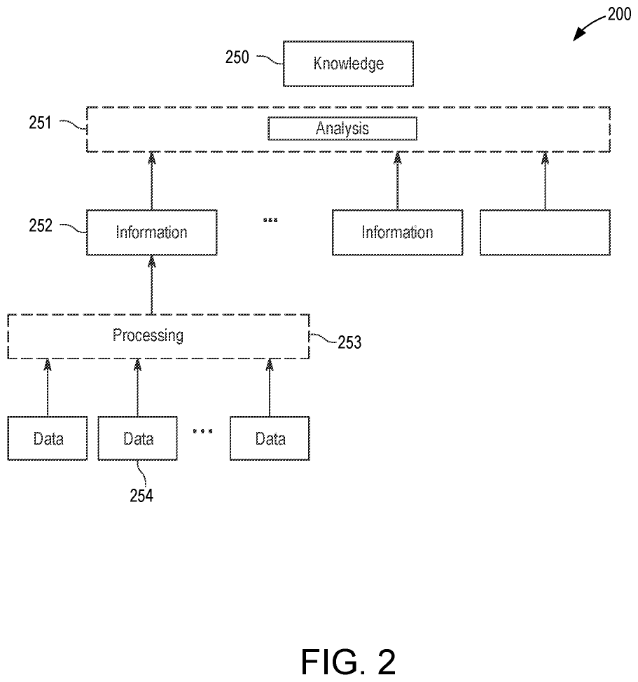

As referred to herein, “knowledge” is conceptually a state of understanding that is obtained through experience and analysis of collected information, such as raw data. A function of vehicular knowledge networking, as disclosed herein, is the capability to transform data, such as raw data collected from vehicle sensors, into searchable knowledge, and subsequently to create and distribute this knowledge with various life cycles and relevance. Referring now to FIG. 2, a conceptual diagram depicts a hierarchy among data 254, information 252, and knowledge 250. As seen in FIG. 2, the hierarchy can include data 254 which is a piece of a recorded experience, such as vehicular speed mph, time t, position p that may be collected as raw data from the vehicle's sensors. In addition, the hierarchy can include information 252 which is pieces of data 254 that have been subjected to processing 253. Thus, data 254 can be contextual “meaningful.” For instance, continuing with the example, the aforementioned raw data 254 from the vehicle can be processed to ascertain meaningful information 252 about the vehicle, such as “the vehicle was moving at a speed mph at time t and at position p.” Further, FIG. 2 illustrates that information 252 can be subjected to analysis 251 in order to derive knowledge 250. It is knowledge 250 that is the most contextual-rich in comparison to data 254 and information 252, which is as illustrated by knowledge 250 being at the top of the hierarchy. As alluded to above, knowledge 250 can be considered as a fact, a belief extracted by analyzing patterns in information 252. For instance, knowledge 250 can be created through analysis 251 of multiple instances of information 252 and it is a fact or a belief that represents the hidden relationship among the information 252. Again, continuing with the example, knowledge 250 can be inferred insight surrounding the vehicle, where knowledge 250 identifies that sequential conflicts happen the most in an area X (related to vehicle's location P), thus X is a risky zone. The creation of knowledge 250 may require computationally hungry algorithms and a set of information 252 and/or data 254 that are potentially from multiple sources (e.g., vehicles). In operation, the vehicular knowledge network depicted in FIG. 2 organizes vehicle sensor measurements into data 254, information 252, and knowledge 250. Moreover, contextual data (also referred to herein as contextual features) for knowledge define a degree of similarity in data 254, information 252 and knowledge 250. For instance, types of data 254 that describe various situational conditions that the vehicle is traveling in at a location, such as road geometry, traffic flow/congestion, weather conditions, and the like, can be collected to form a contextual frame around that location, and ultimately a context for the knowledge 250 for that location. Restated, the disclosed embodiments use certain data 254 as contextual features that link a contextual relevance, namely a context, to the corresponding knowledge 250. Further, the contextual features can be analyzed to determine whether knowledge 250 is in the right context (e.g., having similar contextual features) for a specific vehicle query.

One challenge in creating knowledge is that different vehicular networking nodes may create knowledge of varying levels of benefit because each node has access to different distributions of raw data. For example, a vehicle may have access to a limited amount, a limited diversity, and/or limited type of raw data as compared to, for example, a remote server. Thus, knowledge created from the vehicle's access to particular in-range nodes may be limited in benefit, for example, in terms of accuracy relative to knowledge created by the remote server. As an illustrative example, a vehicle may create knowledge that determines exit probabilities for a roundabout when the vehicle is entering the roundabout. However, due to limitations in the raw data available to the vehicle, the accuracy of the exit probability may need improvement. For example, the exit probability determined by the knowledge created at the vehicle may be 50% accurate, which may be unreliable for providing useful knowledge-based guidance. Whereas, a remote server, having access to a larger data distribution, may generate knowledge that is 80% accurate.

Thus, context-based knowledge refinement, as disclosed herein, can be utilized in various implementations to improve benefits (e.g., in terms of accuracy) of knowledge by combining knowledge according to contextual features and providing merged knowledge to a vehicle. Disclosed embodiments may provide for a process that assigns various contextual features to knowledge during a knowledge cycle, particularly while the knowledge is created (e.g., forming a contextual frame for knowledge), leverages these contextual features when the knowledge is refined, and forwards the knowledge to be utilized by entities in the vehicular knowledge network. A knowledge cycle, as described herein, includes several interrelated stages that involve dissemination and utilization of knowledge, including: knowledge creation; knowledge storing; knowledge networking; and knowledge refining (e.g., knowledge transfer and knowledge composition). The aforementioned knowledge cycle, the entities involved in the communication (e.g., vehicles, infrastructure, etc.), the vehicular network (e.g., vehicle-to-vehicle networking, vehicle-to-cloud networking, etc.), data (e.g., knowledge), and functionality related to creating and using knowledge can be referred to collectively as “vehicular knowledge networking.” Consequently, by making certain that knowledge is refined and used in the correct context, the disclosed embodiments ensure that knowledge is increasingly accurate and beneficial within the vehicular knowledge network, thereby realizing improved vehicle/driver safety features.

In an illustrative example of context-based knowledge refinement, according to the present disclosure, a first vehicle may execute a knowledge creation stage during which first knowledge is generated related to a driving environment based on raw data collected by the first vehicle while traveling in the driving environment. Contextual features of the driving environment can be inferred, for example, by the first vehicle based on the raw data and associated with the first knowledge. However, the first knowledge may be limited in terms of performance-such as, but not limited to, accuracy, benefit (e.g., utilization), diversity, lifetime, among others-due to limitations in the raw data available to the first vehicle. To improve the performance of the first knowledge, a knowledge refining stage may be executed, in which a plurality of vehicular knowledge networking nodes can be identified based on the inferred contextual features. Each vehicular knowledge networking node holds its own knowledge (sometimes referred to herein as node knowledge) that is associated with a set of contextual features (sometimes referred to herein as node contextual features). According to various examples disclosed herein, a set of node contextual features of each identified vehicular knowledge networking node may include a subset of the contextual features associated the first knowledge, such that each set of node contextual features may include at least one of the contextual features of the first knowledge. In an illustrative example, the vehicular knowledge networking nodes are identified such that the set of node contextual features across the identified vehicular knowledge networking nodes collectively comprise each of the contextual features associated with the first knowledge (e.g., collectively covering each of the contextual features of the first knowledge). The node knowledge of each of the identified vehicular knowledge networking nodes can be combined with the first knowledge by traversing a communication path (sometimes referred to herein as a loop or cycle) formed through the identified vehicular knowledge networking nodes to generate merged knowledge. The merged knowledge can be associated with the context (e.g., set of contextual features) inferred by the first vehicle. Consequently, the disclosed embodiments ensuring that the knowledge used for knowledge-based guidance is increasingly accuracy and beneficial (e.g., performance is improved) relative to the first knowledge due to exposure to increasingly diverse distributions in raw data.

The merged knowledge can then be transmitted to the first vehicle or another vehicle, which can be used to provide knowledge-based guidance. For example in the case of another vehicle, the vehicle may be traveling in the driving environment at a time subsequent to the first vehicle and may query for knowledge of the driving environment by providing current conditions of the driving environment (e.g., current contextual features inferred by the vehicle). Based on a match (e.g., substantially similar or identical) between current conditions and a context associated with merged knowledge, the merged knowledge can be retrieved and transmitted to the other vehicle for providing knowledge-based guidance with improved performance relative to knowledge created locally at a vehicle in the driving environment. In some examples, the context-based knowledge refinement disclosed herein may be executed based on (e.g., responsive to) the query for knowledge from the other vehicle. For example, the first knowledge may have been transmitted to a vehicular knowledge networking node, such as a remote server, after creation at the first vehicle. Upon receiving the query from the other vehicle, a plurality of vehicular knowledge networking nodes may be identified and the first knowledge refined, as described above. The resulting merged knowledge can then be transmitted to the other vehicle. In another example, the merged knowledge may be ready for transmission prior to receiving the query.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

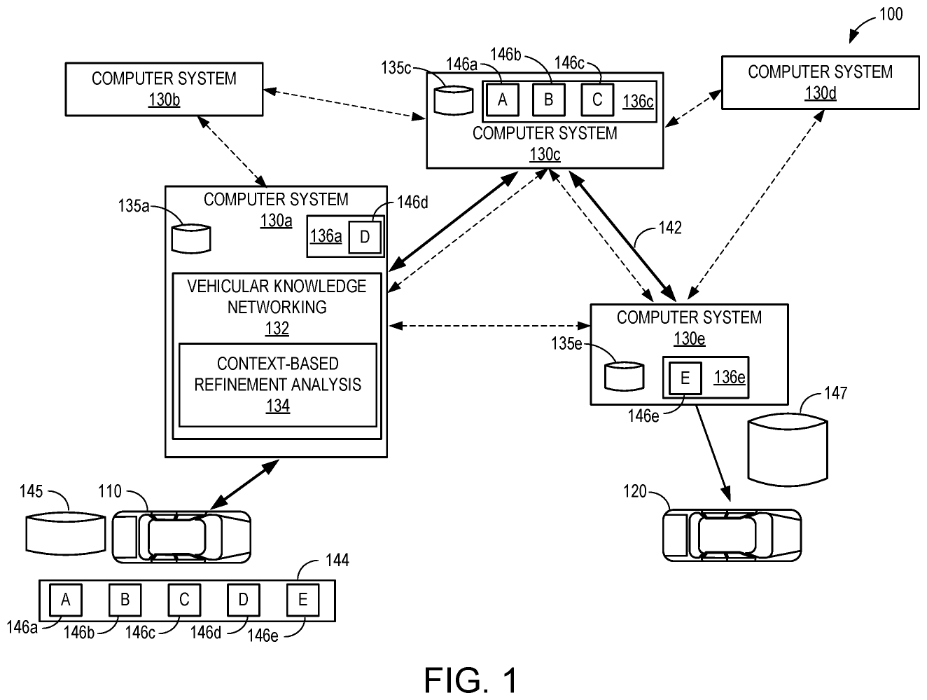

FIG. 1 is a schematic diagram of an example vehicular knowledge network system 100 in accordance with embodiments disclosed herein. The system 100 includes a vehicle 110 traveling in a driving environment, such as on a section of roadway. The roadway may feature any type of traffic signals, roadway or traffic patterns, roadway hazards, etc. The driving environment may include potentially risky, confusing, or dangerous driving environments that are not shown (e.g., roundabouts, exits, and the like).

The embodiments disclosed herein may be implemented with any of a number of different vehicles and vehicle types. For example, embodiments disclosed herein may be used with automobiles, trucks, motorcycles, recreational vehicles and other like on-or off-road vehicles. In addition, the principals disclosed herein may also extend to other vehicle types as well. Although the example described with reference to FIG. 1 is a type of semi-autonomous vehicle, the systems and methods described herein can be implemented in other types of vehicles including autonomous vehicles, vehicles with automatic controls (e.g., dynamic cruise control), or other vehicles. The disclosed embodiments can be implemented in any type of vehicles including gasoline-or diesel-powered vehicles, fuel-cell vehicles, hybrid-electric vehicles (HEV), BEVs, or other vehicles.

Vehicle 110 can be a semi-autonomous vehicle, such as a vehicle having assisted driving capabilities, which also implements the vehicular knowledge networking and improved knowledge cycle functions, as disclosed herein. “Semi-autonomous operational mode” means that a portion of the navigation and/or maneuvering of the vehicle 110 along a travel route is performed by one or more computing systems, and a portion of the navigation and/or maneuvering of the vehicle 110 along a travel route is performed by a human driver. In examples disclosed herein, navigation and/or maneuvering may be based on knowledge-based guidance. One example of a semi-autonomous operational mode is when an adaptive cruise control system is activated. In such case, the speed of a vehicle 110 can be automatically adjusted to maintain a safe distance from a vehicle ahead based on data received from on-board sensors, but the vehicle 110 is otherwise operated manually by a human driver. Upon receiving a driver input to alter the speed of the vehicle (e.g., by depressing the brake pedal to reduce the speed of the vehicle), the speed of the vehicle is reduced. Thus, with vehicle 110 operating as a semi-autonomous vehicle, a response can be partially automated. In an example, the controller communicates a newly generated (or updated) control to the vehicle 110 operating as a semi-autonomous vehicle. The vehicle 110 can automatically perform some of the desired adjustments (e.g., accelerating) with no human driver interaction. Alternatively, the vehicle 110 may notify a driver that driver input is necessary or desired in response to a new (or updated) safety control.

Alternatively, or in addition to the above-described modes, vehicle 110 can have one or more autonomous operational modes. As used herein, “autonomous vehicle” means a vehicle that is configured to operate in an autonomous operational mode. “Autonomous operational mode” means that one or more computing systems of the vehicle 110 are used to navigate and/or maneuver the vehicle along a travel route with a limited level of input from a human driver which varies with the operational mode. In examples disclosed herein, the autonomous operation may be based on knowledge-based guidance. As such, vehicle 110 can have a plurality of autonomous operational modes, where each mode correspondingly responds to a controller, with a varied level of automated response. In some embodiments, the vehicle 110 can have an unmonitored autonomous operational mode. “Unmonitored autonomous operational mode” means that one or more computing systems are used to maneuver the vehicle along a travel route fully autonomously, requiring no input or supervision required from a human driver. Thus, as an unmonitored autonomous vehicle 110, responses can be highly, or fully, automated. For example, a controller can be configured to communicate controls so as to operate the vehicle 110 autonomously and safely. After the controller communicates a control to the vehicle 110 operating as an autonomous vehicle, the vehicle 110 can automatically perform the desired adjustments (e.g., accelerating or decelerating) with no human driver interaction. Accordingly, vehicle 110 can operate any of its components autonomously, such as an engine.

According to the embodiments disclosed herein, the vehicle 110 can be configured to implement vehicular knowledge networking including a knowledge cycle, as disclosed herein. That is, for example, each vehicle 110 can be equipped to convert raw data (e.g., an example of data 254) into knowledge 145 (e.g., an example of knowledge 250), where the knowledge 145 provides insight regarding traffic events, driving environment, driving conditions, congestion, and the like. The raw data may be generated at vehicle 110 (e.g., from sensor of vehicle 110) and/or obtained through communication with connected vehicles in the driving environment. The raw data may be referred to herein as vehicle data or sensor data. The vehicle 110 can utilize knowledge 145 in order to optimize various vehicular applications. For example, the vehicle 110 can leverage vehicular knowledge networking in order to execute a knowledge-based guidance application. Thus, by implementing knowledge-based guidance application, vehicle 110 can quantify the conditions in their environment, identify the knowledge of the conditions, and leverage the knowledge to generate guidance for the driver to improve vehicle operation.

In various embodiments, vehicle 110 can be equipped with on-vehicle sensors that collect real-time data while driving, where the data (e.g., speed, temperature, road conditions, etc.) is pertinent to driving and/or maneuvering operations. This data, also referred to herein as raw data or vehicle data, can then be communicated, stored, analyzed in accordance with various vehicular networking technologies, and analyzed in order to transform the data into knowledge 145. For instance, the speed at which different vehicles move along a road in a certain location can be collected, by the respective vehicles, over time. The sensor data can be processed in accordance with the disclosed vehicular knowledge networking capabilities to provide meaningful information in the form of knowledge 145 and the contextual features 146a-146e which constitute its corresponding context 144. Multiple pieces of sensor data, possibly from vehicle 110 and/or different vehicles can be used to infer inner relationships or repeating patterns and contextual relevance that may be found in data, thereby extracting insight on this data that can serve as knowledge 145 and its context 144 (e.g., the set of contextual features 146a-146e). For example, the vehicle 110 (or a computer system) may have the capabilities to create contextual features maps for the driving environment in which vehicle 110 travels, and extract meaningful contextual information that enables creation of context 144 in the form of the set of contextual features 146a-146e for knowledge 145.

FIG. 1 depicts the vehicle 110 as a connected vehicle that is communicable connected to one or more computer system 130a-130e. As used herein, “connected vehicle” refers to a vehicle that is actively connected to edge devices, other vehicles, and/or a cloud server via a network through V2X communication comprising V2I, V2C, C2V and/or V2V communications. For example, the vehicle 110 and vehicles in the vicinity of vehicle 110 within the driving environment are connected vehicles that include communication circuitry (and other hardware/software providing such capabilities installed thereon) which is capable of wireless communication (e.g., V2X, V2I, V2V, etc.) that enables active connections to other vehicles and/or communication devices. As an example, vehicle 110 communicates with other vehicles using vehicle-to-vehicle (V2V), communicates to with a remote cloud or edge server through vehicle-to-cloud (V2C) communication, and communicates with roadside equipment of a roadside infrastructure through vehicle-to-infrastructure (V2I) communication. In another example, vehicle 110 can communicate with devices using vehicle-to-everything (V2X) communication. Accordingly, the vehicle 110 and the computer system 130a being within the vicinity of the vehicle 110 (e.g., within a communication range of the communication interface implemented) can be considered a hub of the vehicular knowledge network system 100. Generally, vehicular knowledge network system 100 supports several functions, including, but not limited to: executing a knowledge cycle (e.g., including knowledge creation and knowledge refinement), as disclosed herein.

In the example of FIG. 1, entities in the vehicular knowledge network (e.g., vehicular knowledge networking nodes), for example, the vehicle 110 and computer systems 130a-130e, can be configured to implement various aspects of vehicular knowledge networking disclosed herein. In embodiments of the present disclosure, functions supporting vehicular knowledge networking and the improved knowledge cycle can be performed as part of a training process, which may be carried out using one or more of computer systems 130a-130e. In the example of FIG. 1, computer system 130a is depicted as including a vehicular knowledge networking system 132 and a context-based refinement analysis system 134. For example, the computer system 130a might include one or more processors, controllers, control modules, or other processing devices, where the vehicular knowledge networking system 132 and a context-based refinement analysis system 134 may be implemented as hardware processor(s). The vehicular knowledge networking system 132 and a context-based refinement analysis system 134 may also be implemented as software on the computer system 130a, such as instructions, machine-readable code, or computer program components. In another example, vehicular knowledge networking system 132 and a context-based refinement analysis system 134 may be implemented as a combination of hardware and software. Each of computer systems 130b-130e may be substantially similar to computer system 130a, thereby including their own instance of a knowledge networking system and a context-based refinement analysis system.

In the example of FIG. 1, the computer systems 130a-130e are illustratively implemented as remote servers (e.g., edge servers, centralized cloud servers, and the like) that are interconnected forming part the vehicular knowledge network. However, the computer systems 130a-130e may be implemented as any device comprising a computation system. For examples, one or more of computer systems 130a-130e may be implemented as a roadside equipment operating as an edge server. In yet another example, one or more of computer systems 130a-130e may be implemented as a connected vehicle.

According to the embodiments disclosed herein, each of computer systems 130a-130e can be configured to implement vehicular knowledge networking including a knowledge cycle, as disclosed herein. That is, for example, each computer system 130a-130e can be configured to convert raw data (e.g., an example of data 254) into respective node knowledge (e.g., an example of knowledge 250) that provides insight regarding traffic events, driving environment, driving conditions, congestion, and the like. The raw data may be generated at connected vehicles and/or obtained through communication with the connected vehicles. In another example, each connected vehicle may generate knowledge as described above, which can be provided to the computer systems 130a-130e. In this case, each computer system 130a-130e may execute knowledge composition to combine received knowledge and generate node knowledge. In the example of FIG. 1, computer system 130a, 130c, and 130e are shown storing node knowledge 135a, 135c, and 135e, respectively. However, computer systems 130b and 130d may also store their own respective node knowledge. The node knowledge may be distributed throughout the vehicular knowledge network system 100 for a knowledge-based guidance applications to control vehicular operations.

Similar to knowledge 145, the node knowledge at each computer system 130a-130e may be associated with a context, which comprises a set of contextual features (sometimes referred to herein as a set of node contextual features). For example, as shown in FIG. 1, node knowledge 135a can be associated with node context 136a, node knowledge 135c can be associated with node context 136c, and node knowledge 135e can be associated with node context 136e. Similar associations can be established in computer systems 130b and 130d according to the node knowledge and a node context stored thereon. As an example, each computer system 130a-130e can receive contextual features from one or more connected vehicles, where the set of contextual features represent conditions of a driving environment for which respective node knowledge is generated. For example, vehicles that have traversed a driving environment represented by contextual features of node context 136a may have leveraged their capabilities (e.g., sensors) to collect vehicle data that was descriptive of the conditions experienced at the time while driving. This vehicle data, representative of a set of contextual features of the driving environment, can be received and further analyzed by the computer system 130a (e.g., by context analysis system 133) to provide a node context 136a for the node knowledge 135a that will be created for the driving environment according to the set of contextual features, as described above in connection with FIG. 2. That is, for example, the computer system 130a can analyze the vehicle data (e.g., generated by a plurality of vehicles) of a location, in order to generate one or more contextual feature maps that infer a node context 136a surrounding node knowledge 135a corresponding to the contextual features. As noted above, the node context 136a for node knowledge 135a can be created concurrently with the node knowledge 135a itself. Computer systems 130b-130e may be implemented in a manner substantially similar to computer system 130a, as described above.

According to embodiments, knowledge, such as knowledge 145 and node knowledge, can be created by utilizing various methods and/or techniques. For example, knowledge creation can be performed by known data analysis technique, such as, but not limited to, formal language techniques, model-based approaches, deep learning-based methods, and the like. With respect to model-based approaches, knowledge creation can involve performing clustering for knowledge extraction (where a set of objects is grouped in same cluster in terms of similarity) and seasonal-trend decomposition. Model-based knowledge creation can use mathematical models to extract hidden relationships, apply learning techniques to explore the inner relations. Thus, model-based knowledge creation can be modeled as multi-criteria decision making that involves more than one objective, where mathematical optimization methods are applied to optimize objectives simultaneously.

Deep learning-based methods can involve learning inferences of hidden relationships in data, which is explored through deep learning approaches (e.g., machine learning). In some cases, by applying deep learning-based methods, knowledge is created by extracting representative features from input data. Therefore, knowledge created using deep learning-based methods can result in meaningful features or descriptors that have been extracted from collected data (e.g., raw sensor data from vehicles). An example of such knowledge created using a deep learning-based method is: [−5 C°, −3 C°, −2 C°] (e.g., data)→cold (e.g., knowledge).

Formal language can involve forming knowledge as descriptions in a formal language, such as propositional logic. For example, new knowledge can be created by a set of knowledge inference rules, which takes information at the information layer and/or the existing knowledge as input. In applying a formal language technique for knowledge creation, knowledge inference rules are described in a formal language, such as propositional logic as below:
when the tires are slippery, driving in high speed is dangerous
Slippery_Road>High_Speed⇒Danger.
Time_is_6 pm⇒HighTraffic V Holiday

The vehicle 110 may infer the set of contextual features 146a-146e that represent various conditions of the driving environment in which the vehicle is traveling. For example, vehicle 110, while traveling in the driving environment, may leverage capabilities (e.g., sensors) to collect vehicle data descriptive of the conditions experienced at the time while driving through the environment (e.g., at the time the raw data used to generate knowledge 145 is collected), such as traffic flow, vehicle/driver type, congestion, type of objects at the location, risk caused by other drivers, weather conditions, and the like. This vehicle data, representative of the set of contextual features, can be provided as “context” for the knowledge 145. That is, for example, the vehicle data can be analyzed, in order to generate a set of one or more contextual feature that infer a context surrounding knowledge corresponding to the contextual features comprised thereof. Contextual features can be derived from the raw data by executing known time series analysis techniques on the raw sensor data. According to the embodiments disclosed herein, the context for knowledge can be created concurrently with the knowledge itself, so as to eliminate additional overhead and/or delays when the knowledge is actually needed (e.g., knowledge forwarded to entities of the vehicular knowledge network). In other words, the context that corresponds to an instance of knowledge can be created during its knowledge cycle (e.g., creating the knowledge). The knowledge cycle can be described as the overall steps for creating, refining, and/or distributing knowledge in vehicular knowledge networking, such as vehicular knowledge network system 100.

In the example of FIG. 1, knowledge 145 can be related to a context 144 in the form of the contextual features 146a-146e for a knowledge-based guidance application. For instance, knowledge 145 can provide insight on a type of maneuvering or other vehicle operating conditions that are often experienced by vehicles according to the contextual features 146a-146e. Contextual features 146a-146e can provide insight to static properties for the driving environment (and its knowledge) including, but not limited to: the location, road geometry, traffic rules, and the like. Contextual features 146a-146e can also provide insight to dynamic properties for the driving environment (and its knowledge) including, but not limited to: traffic flow, vehicle/driver type, congestion, type of objects at the location, risk caused by other drivers, weather, etc. Thus, the context 144 provides a contextual relationship inferring the conditions surrounding location at a time when the knowledge 145 was created. Each contextual feature 146a-146e may represent a static or dynamic property of the context. For examples, contextual feature 146a may represent a location of the driving environment and contextual feature 146b may represent a road geometry, while contextual features 146c, 146d, and 146e may represent traffic flow, driver type, and weather, respectively. While five contextual features are illustrated in the example of FIG. 1, embodiments disclosed herein may include any number of contextual features depending on the environment in which vehicle 110 is present and the sensor set of the vehicle (e.g., depending on the raw data available to the vehicle).

In operation, knowledge 145 created at the vehicle 110 may be limited in terms of a performance metric-such as, but not limited to, accuracy, benefit (e.g., utilization), diversity, lifetimes, among others-due to vehicle data and/or information used to generate the knowledge being limited in terms of distribution, diversity, and/or amount. To improve the knowledge through knowledge refinement, knowledge 145 can be distributed to vehicular knowledge network system 100, which execute context-based knowledge refinement to improve the performance metric.

One or more entities of the vehicular knowledge network system 100 can be configured to execute context-based knowledge refinement techniques. For example, as described above, knowledge 145 can be generated at vehicle 110 and associated with a context 144. The context 144 comprises a set of contextual features 146a-146e, which can be inferred from the raw data used to generate the knowledge 145. Based on the contextual features 146a-146e, one or more of computer systems 130a-130e can be identified. For example, node context at each computer system 130a-130e can be examined to locate node context that comprise subset of the contextual features 146a-146e (e.g., at least one of the contextual features 146a-146e) and the computer systems 130a-130e holding the located node context can be identified. The vehicular knowledge network can be searched until each contextual feature 146a-146e are located a collection of node contexts and respective computer systems 130a-130e are identified. A communication path 142 can then be established through the vehicular knowledge network that comprises each identified computer system 130a-130e in a sequential order of traversal along the communication path 146. In examples, the communication path 142 may include identifiers (e.g., IP address, MAC address, or the like) of the identified computer systems 130a, 130c, and 130e.

The communication path 142 can then be traversed and knowledge composition techniques can be executed at each of the identified computer systems (e.g., by context-based refinement analysis system 134). That is, each identified computer system can be executed to combine its respective node knowledge with knowledge 145 to generate intermediate-merged knowledge, which is passed to a next computer system along the communication path 142, ultimately generating merged knowledge 147. The merged knowledge 147 can be transmitted to a vehicle 120 using context-based knowledge forwarding techniques and used to perform knowledge-based guidance at the vehicle 120. Accordingly, the merged knowledge 147 provides improved performance relative to the first knowledge due combining with node knowledge that is generated from increasingly diverse and/or larger amounts of raw data.

As alluded to above, one or more of the computer systems 130a-130e can be identified based on contextual features 146a-146e associated with the knowledge 145. Each computer systems 130a-130e stores one or more respective node knowledge associated with respective node context, each of which comprises a plurality of node contextual features. The node context at each computer system 130a-130e can be analyzed to determine whether or not the respective node context includes a subset of the contextual features 146a-146e (e.g., at least one of the contextual features 146a-146e is included in the node contextual features). From the computer systems 130a-130e determined to have a respective node context that includes a subset of the contextual features 146a-146e, the communication path 142 can be formed initiating at vehicle 110 and passing through each of the identified computer systems 130a-130e, such that the communication path 142 traverse one or more computer systems 130a-130e that collectively cover all of contextual features 146a-146e. For example, as shown in FIG. 1, node context 136a comprises a plurality of contextual features including contextual feature 146d, node context 136c comprises a plurality of contextual features including contextual features 146a, 146b, and 146d, and node context 136e comprises a plurality of contextual features including contextual feature 146e. As such, communication path 142 can be established through the vehicular knowledge network that traverses computer systems 130a, 130c, and 130e, such that the computer systems 130a, 130c, and 130e collectively comprise each of contextual features 146a-146c.

According to embodiments, communication path 142 (also referred to as a network loop or a cycle) can be established by utilizing various methods and/or techniques. For example, known graph analysis and cycle detection algorithms, such as bread-first search algorithms, can be executed to identify computer systems and form paths that collectively cover all of the contextual features 146a-146e. In some examples, an initial path can be identified using a random approach in which each computer system is selected at random until each contextual feature 146a-146e is covered by a computer system.

Identification of the one or more of computer systems 130a-130e can be performed by one or more entities of system 100. For example, vehicle 110 may generate knowledge 145 and determine that a performance metric of the knowledge 145 is below a set threshold. Upon making this determination, vehicle 110 may trigger context-based knowledge refinement by querying computer systems of the vehicular knowledge network for a computer system having a node context comprising at least one of contextual features 146a-146e. In the example of FIG. 1, computer system 130a may respond indicating that node context 136a includes contextual feature 146d. Vehicle 110 may then transmit knowledge 145 and contextual features 146a-146e to computer system 130a. Computer system 130a (e.g., context-based refinement analysis system 134) may execute knowledge composition to combine knowledge 145 with its node knowledge 135a, thereby generating a first intermediate-merged knowledge. Computer system 130a (e.g., context-based refinement analysis system 134) search for a next computer system that comprises a node context that has at least one of the contextual features 146a-146c and 146e. Contextual feature 146d is no longer searched because this contextual feature was already located. The process can be repeated at each computer system along the communication path 142 to successively execute knowledge composition using its node knowledge and a preceding intermediate merged knowledge, with the final computer system (e.g., computer system 130e) ultimately generating merged knowledge 147 using its node knowledge (e.g., knowledge 135e) with a preceding intermediate-merged knowledge.

In another example, the vehicular knowledge network can be searched by one or more computer systems 130a-130e (e.g., context-based refinement analysis system 134) based on the query from vehicle 110 to locate one more of computer systems 130a-130e that collectively cover the contextual features 146a-146e prior to vehicle 110 sending knowledge 145 for knowledge composition. For example, upon detecting the performance metric is below a set threshold, vehicle 110 can package the context 144, including contextual features 146a-146e, into a query that is provided to one or more computer system of the system 100. The receiving computer system executes context-based refinement analysis system 134 on the contextual features 146a-146e from vehicle 110 to locate computer systems that collectively cover each contextual feature 146a-146e (e.g., computer systems 130a, 130c, 130e in this example) and establish communication path 142. The communication path 142 can then be provided to vehicle 110, including identifiers and sequential order of the identified computer systems along the communication path 142 and the vehicle 110 may transmit knowledge 145 and contextual features 146a-146e to the first computer system along the path (e.g., computer system 130a). Computer system 130a executes knowledge composition (e.g., context-based refinement analysis system 134) to merge node knowledge 135a with knowledge 145 to generate intermediate-merged knowledge. Computer system 130a then transmits this intermediate-merged knowledge to a next computer system (e.g., computer system 130c in this example) that executes knowledge composition to generate a next intermediate-merged knowledge. The process repeats at each computer system along the communication path 142 to successively execute knowledge composition using its node knowledge and a preceding intermediate-merged knowledge until the final computer system ultimately generates merged knowledge 147.

As alluded to above, a knowledge refinement stage of a knowledge cycle can include knowledge composition. Knowledge composition merges knowledge at different entities in order to create new merged knowledge. In such case, knowledge may be combined/merged according to various rules, criteria, and methods, which ultimately creates new knowledge and maximizes its benefits. For example, vehicle 110 can create a first set of knowledge 145, such as exit probability of a roundabout, and a computer system (e.g., computer system 130a) can create a second set of node knowledge 135a, also about the exit probability of the roundabout. As a result, there are different sets of knowledge that have been created using different methods. Continuing with this example, by performing knowledge composition, new knowledge regarding the exit probability of a roundabout, can be formed by combining/merging both the first and second sets of knowledge 145 and node knowledge 135a. Merging/combing sets of knowledge can include known techniques, such as but not limited to, aggregation through summation of the sets of knowledge, extracting median of the sets of knowledge, extracting a maximum of the sets of knowledge, averaging the sets of knowledge together, extracting a mean of the sets of knowledge. Continuing with the above example in which knowledge predicts exit probability, a maximum technique may receive a various different knowledge and chooses the most accurate one, while discarding the others. In another case, an averaging technique may average the various different knowledge and redistribute the aggregated model.

Merged knowledge 147 can be stored on the vehicular knowledge network in association with context 144 defined by contextual features 146a-146e. In the example FIG. 1, computer system 130e stores merged knowledge 147 and associated context 144; however, the merged knowledge 147 and associated context 144 may be stored ay any entity of system 100 for distribution via context-based knowledge forwarding and used for knowledge-based guidance. For example, computer system 130e can employ context-based knowledge forwarding capabilities, such that the merged knowledge 147, corresponding to context 144, can be retrieved based on a match (e.g., substantially similar or identical to) between a current conditions in which vehicle 120 travels and the context 144 associated with merged knowledge 147. The merged knowledge 147 can be utilized by trained machine learning models to generate the knowledge-based guidance for operating vehicle 120.

As an illustrative example, vehicle 120 may infer conditions using sensors to collect raw data and derive contextual features of the current conditions, as described above. The current contextual features, which constitute a current context, can be packaged into a query for knowledge related to the current conditions and provided to a computer system (e.g., computer system 130e in this example) as a query for knowledge. The vehicular knowledge networking system executed on the computer system can be configured to analyze the query for knowledge based on the context, such that knowledge having a similar context is forwarded to vehicle 120 in response to the query. For example, vehicle 120 can derive contextual features representing conditions currently experienced by vehicle 120. The contextual features be used to retrieve merged knowledge 147. In an example, merged knowledge 147 can be returned to vehicle 120 when the detected conditions (e.g., contextual features) are at least substantially similar to, if not identical to, context 144 associated with merged knowledge 147. Conditions may be considered substantially similar where the conditions detected by vehicle 120 includes at least a threshold amount (e.g., percentage, number, or the like) of the contextual features included in context 144. The threshold in some examples may be 80% (e.g., 4 conditions in a case where context 144 contains 5 contextual features 146a-146e), but other thresholds may be used as desired. Merged knowledge 147 may be uploaded to vehicle 120 for providing knowledge-based guidance within the current conditions. Thus, the vehicular knowledge networking system 100 forms a knowledge network among entities, where vehicles 110 and 120 can deduce and share knowledge for enhanced driver/vehicle safety applications (e.g., risk reasoning) instead of large volumes of raw sensor data and information (which reduces the cost and volume of communication).

Additional examples and explanation of context-based knowledge forwarding are described in U.S. patent application Ser. No. 18/300,367, the disclosure of which is incorporated herein by reference in its entirety.

The vehicle 120 can then execute knowledge-based guidance applications (such as safety maneuvers) as a result of the merged knowledge 147. The merged knowledge 147 may have a contextual relationship with the driving environment in which vehicle 120 is traveling, such that that the executed maneuvers performed based on merged knowledge 147 are applicable for the current conditions, or context, of the risk zone. As an example, if the merged knowledge 147 indicates that the driving environment is a risky zone and/or the nearby vehicles are identified as risky user, certain safety maneuvers may be autonomously performed by vehicle 120, such as slowing down, because of the risk and the situational context of the driving environment.

Additional examples and explanation of mitigation techniques can be found, for example, in U.S. application Ser. No. 17/959,866, filed on Oct. 4, 2022, entitled “SYSTEMS AND METHODS TO MANAGE DRIVERS UNDER ABNORMAL DRIVING;” U.S. application Ser. No. 17/005,258, filed on Aug. 27, 2020, entitled “SYSTEMS AND METHODS TO GROUP AND MOVE VEHICLES COOPERATIVELY TO MITIGATE ANOMALOUS DRIVING BEHAVIOR;” and U.S. Pat. No. 11,414,088, filed on Jan. 16, 2020, entitled “ANOMALOUS DRIVER DETECTION SYSTEM,” the disclosures of which are incorporated herein by reference in their entirety.

In examples, vehicle 120 may represent the same vehicle as vehicle 110 or different vehicles. In the case where vehicle 120 is the same vehicle as vehicle 110, the context 144 detected by vehicle 110 may be used for both context-based knowledge refinement, as well as context-based knowledge forward. In this case, the merged knowledge 147 may be transmitted back to vehicle 110 based on the context 144. In the case where vehicle 110 and vehicle 120 are different vehicles, vehicle 120 may detect current conditions and query for knowledge at a point in time after merged knowledge 147 is generated.

Receiving merged knowledge 147 having a context that corresponds to current conditions in which a vehicle travels suggests that the knowledge will be more beneficial for the vehicle to make an accurate risk analysis and initiate an appropriate safety response that is most applicable to the current conditions. Additionally, having merged different knowledge from different entities on a context basis, as described above, suggests that the merged knowledge 147 will have improved performance relative to each different knowledge individually due to increased diversity and data distribution among raw data from which each individual knowledge was generated. The merged knowledge 147 can be shared with the vehicle through V2C communications.

As previously described, the vehicle 120 can then execute knowledge-based guidance applications (such as safety maneuvers) as a result of the knowledge 145 received. Furthermore, due to context-based knowledge forwarding, the knowledge 145 has a specific contextual relationship operating environment 102 such that that the executed maneuvers performed based on knowledge 145 are applicable for the current conditions, or context, of the risk zone. As an example, if the knowledge 145 indicates that operating environment 102 is a risky zone and/or the nearby vehicles 104A-104G are identified as risky user, certain safety maneuvers may be autonomously performed, such as slowing down, because of the risk and the situational context of the driving environment.

The vehicular knowledge networking system 100 and context-based knowledge refinement techniques can thus realize enhanced safety applications, such as risk reasoning, based on knowledge of a current traffic environment, generated from increasingly diverse raw data, which improves the vehicle/driver safety by making preventive and proactive decisions to minimize the threat for all vehicles that are and/or will be affected by the riskiness. Furthermore, by refining knowledge (as opposed to large amounts of raw data) and analyzing context for that knowledge using a distinct pre-process (e.g., contextual feature maps are used to prepare the knowledge cycle beforehand) the vehicular knowledge networking system 100 may mitigate large delays and overhead which is not tolerable in time-critical responses.

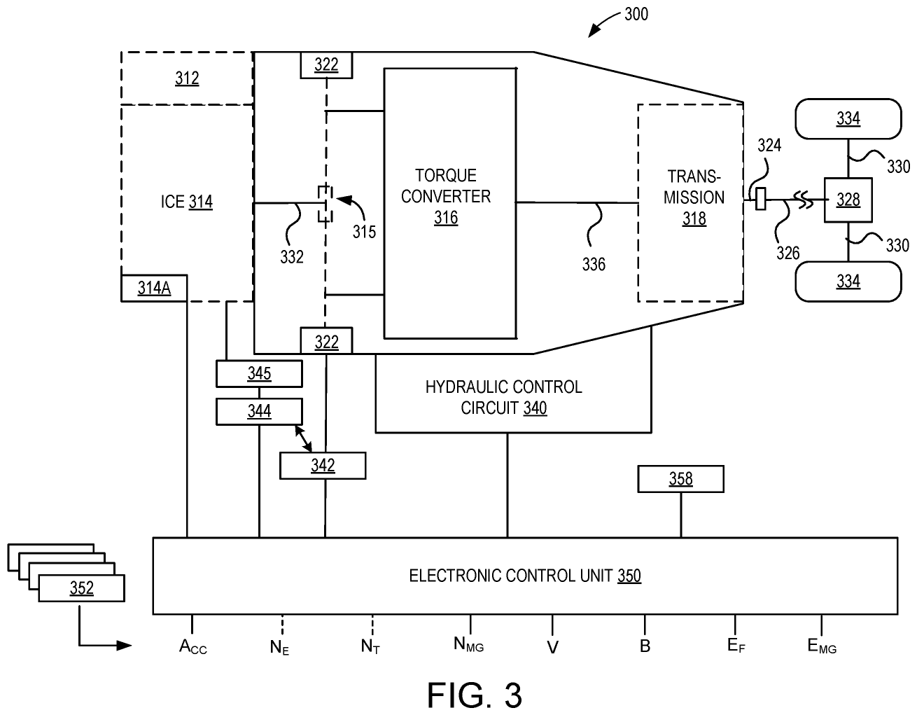

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 3. Although the example described with reference to FIG. 3 is a hybrid type of vehicle, the systems and methods for context-based knowledge refinement can be implemented in other types of vehicle including gasoline- or diesel-powered vehicles, fuel-cell vehicles, electric vehicles, or other vehicles.

FIG. 3 illustrates a drive system of an example vehicle 300 that may include an internal combustion engine 314 and one or more electric motors 322 (which may also serve as generators) as sources of motive power. Vehicle 300 may be an example implementation of vehicle 110, 120, 104A-104G and/or 105A-105G of FIGS. 1A and 1B. Driving force generated by the internal combustion engine 314 and motors 322 can be transmitted to one or more wheels 334 via a torque converter 316, a transmission 318, a differential gear device 328, and a pair of axles 330.

As an HEV, vehicle 300 may be driven/powered with either or both of engine 314 and the motor(s) 322 as the drive source for travel. For example, a first travel mode may be an engine-only travel mode that only uses internal combustion engine 314 as the source of motive power. A second travel mode may be an EV travel mode that only uses the motor(s) 322 as the source of motive power. A third travel mode may be an HEV travel mode that uses engine 314 and the motor(s) 322 as the sources of motive power. In the engine-only and HEV travel modes, vehicle 300 relies on the motive force generated at least by internal combustion engine 314, and a clutch 315 may be included to engage engine 314. In the EV travel mode, vehicle 300 is powered by the motive force generated by motor 322 while engine 314 may be stopped and clutch 315 disengaged.

Engine 314 can be an internal combustion engine such as a gasoline, diesel or similarly powered engine in which fuel is injected into and combusted in a combustion chamber. A cooling system 312 can be provided to cool the engine 314 such as, for example, by removing excess heat from engine 314. For example, cooling system 312 can be implemented to include a radiator, a water pump and a series of cooling channels. In operation, the water pump circulates coolant through the engine 314 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 314. In other applications, either or both the water pump and the fan may be operated by electric current such as from battery 344.

An output control circuit 314A may be provided to control drive (output torque) of engine 314. Output control circuit 314A may include a throttle actuator to control an electronic throttle valve that controls fuel injection, an ignition device that controls ignition timing, and the like. Output control circuit 314A may execute output control of engine 314 according to a command control signal(s) supplied from an electronic control unit 350, described below. Such output control can include, for example, throttle control, fuel injection control, and ignition timing control.

Motor 322 can also be used to provide motive power in vehicle 300 and is powered electrically via a battery 344. Battery 344 may be implemented as one or more batteries or other power storage devices including, for example, lead-acid batteries, nickel-metal hydride batteries, lithium ion batteries, capacitive storage devices, and so on. Battery 344 may be charged by a battery charger 345 that receives energy from internal combustion engine 314. For example, an alternator or generator may be coupled directly or indirectly to a drive shaft of internal combustion engine 314 to generate an electrical current as a result of the operation of internal combustion engine 314. A clutch can be included to engage/disengage the battery charger 345. Battery 344 may also be charged by motor 322 such as, for example, by regenerative braking or by coasting during which time motor 322 operate as generator.

Motor 322 can be powered by battery 344 to generate a motive force to move the vehicle and adjust vehicle speed. Motor 322 can also function as a generator to generate electrical power such as, for example, when coasting or braking. Battery 344 may also be used to power other electrical or electronic systems in the vehicle. Motor 322 may be connected to battery 344 via an inverter 342. Battery 344 can include, for example, one or more batteries, capacitive storage units, or other storage reservoirs suitable for storing electrical energy that can be used to power motor 322. When battery 344 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 350 (described below) may be included and may control the electric drive components of the vehicle as well as other vehicle components. For example, electronic control unit 350 may control inverter 342, adjust driving current supplied to motor 322, and adjust the current received from motor 322 during regenerative coasting and breaking. As a more particular example, output torque of the motor 322 can be increased or decreased by electronic control unit 350 through the inverter 342.

A torque converter 316 can be included to control the application of power from engine 314 and motor 322 to transmission 318. Torque converter 316 can include a viscous fluid coupling that transfers rotational power from the motive power source to the driveshaft via the transmission. Torque converter 316 can include a conventional torque converter or a lockup torque converter. In other embodiments, a mechanical clutch can be used in place of torque converter 316.

Clutch 315 can be included to engage and disengage engine 314 from the drivetrain of the vehicle. In the illustrated example, a crankshaft 332, which is an output member of engine 314, may be selectively coupled to the motor 322 and torque converter 316 via clutch 315. Clutch 315 can be implemented as, for example, a multiple disc type hydraulic frictional engagement device whose engagement is controlled by an actuator such as a hydraulic actuator. Clutch 315 may be controlled such that its engagement state is complete engagement, slip engagement, and complete disengagement complete disengagement, depending on the pressure applied to the clutch. For example, a torque capacity of clutch 315 may be controlled according to the hydraulic pressure supplied from a hydraulic control circuit (not illustrated). When clutch 315 is engaged, power transmission is provided in the power transmission path between the crankshaft 332 and torque converter 316. On the other hand, when clutch 315 is disengaged, motive power from engine 314 is not delivered to the torque converter 316. In a slip engagement state, clutch 315 is engaged, and motive power is provided to torque converter 316 according to a torque capacity (transmission torque) of the clutch 315.

As alluded to above, vehicle 300 may include an electronic control unit 350. Electronic control unit 350 may include circuitry to control various aspects of the vehicle operation. Electronic control unit 350 may include, for example, a microcomputer that includes a one or more processing units (e.g., microprocessors), memory storage (e.g., RAM, ROM, etc.), and I/O devices. The processing units of electronic control unit 350, execute instructions stored in memory to control one or more electrical systems or subsystems 358 in the vehicle. Electronic control unit 350 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 3, electronic control unit 350 receives information from a plurality of sensors included in vehicle 300. For example, electronic control unit 350 may receive signals that indicate vehicle operating conditions or characteristics, or signals that can be used to derive vehicle operating conditions or characteristics. These may include, but are not limited to accelerator operation amount (A_{CC}), a revolution speed (N_{E}), of internal combustion engine 314 (engine RPM), a rotational speed (N_{MG}) of the motor 322 (motor rotational speed), and vehicle speed (N_{V}). These may also include torque converter 316 output (N_{T}) (e.g., output amps indicative of motor output), brake operation amount/pressure (B), battery (SOC) (i.e., the charged amount for battery 344 detected by an SOC sensor). Accordingly, vehicle 300 can include a plurality of sensors 352 that can be used to detect various conditions internal or external to the vehicle and provide sensed conditions to electronic control unit 350 (which, again, may be implemented as one or a plurality of individual control circuits). In one embodiment, sensors 352 may be included to detect one or more conditions directly or indirectly such as, for example, fuel efficiency (E_{F}), motor efficiency (E_{MG}), hybrid (internal combustion engine 314+MG 322) efficiency, acceleration (A_{CC}), etc.

In some embodiments, one or more of the sensors 352 may include their own processing capability to compute the results for additional information that can be provided to electronic control unit 350. In other embodiments, one or more sensors may be data-gathering-only sensors that provide only raw data to electronic control unit 350. In further embodiments, hybrid sensors may be included that provide a combination of raw data and processed data to electronic control unit 350. Sensors 352 may provide an analog output or a digital output.

Sensors 352 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect objects in an environment surrounding vehicle 300, for example, traffic signs indicating a current speed limit, road curvature, obstacles, surrounding vehicles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 3 is provided for illustration purposes only as one example of vehicle systems with which embodiments of the disclosed technology may be implemented. One of ordinary skill in the art reading this description will understand how the disclosed embodiments can be implemented with this and other vehicle platforms.

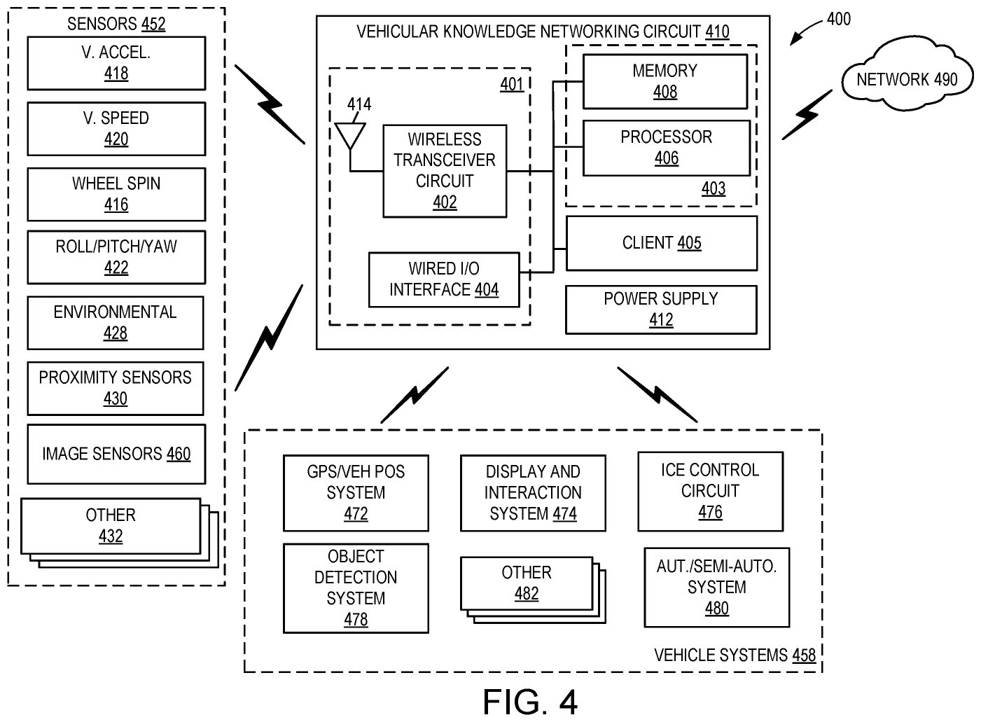

FIG. 4 illustrates an example architecture for knowledge networking system 400 in accordance with one embodiment of the systems and methods described herein. Referring now to FIG. 4, in this example, knowledge networking system 400 includes a vehicular knowledge networking circuit 410, a plurality of sensors 452 and a plurality of vehicle systems 458. Sensors 452 (such as sensors 352 described in connection with FIG. 3) and vehicle subsystems 358 (such as subsystems 358 described in connection with FIG. 3) can communicate with vehicular knowledge networking circuit 410 via a wired or wireless communication interface. Although sensors 452 and vehicle systems 458 are depicted as communicating with vehicular knowledge networking circuit 410, they can also communicate with each other as well as with other vehicle systems. Vehicular knowledge networking circuit 410 can be implemented as an ECU or as part of an ECU such as, for example electronic control unit 350. In other embodiments, vehicular knowledge networking circuit 410 can be implemented independently of the ECU.

Vehicular knowledge networking circuit 410 in this example includes a communication circuit 401, a decision circuit 403 (including a processor 406 and memory 408 in this example) and a power supply 412. Components of vehicular knowledge networking circuit 410 are illustrated as communicating with each other via a data bus, although other communication in interfaces can be included. Vehicular knowledge networking circuit 410 in this example also includes client 405 that can be operated to connect to an edge server of a network 490 to contribute to provide contextual factors, such as current conditions (e.g., representative of contextual factors); create knowledge (e.g., knowledge 145 of FIG. 1); download knowledge (e.g., merged knowledge 147 of FIG. 1) for use by vehicle systems 458, etc.

The decision circuit 403 can comprises a context engine and a knowledge cycle engine. For example, the context engine may be executed by processor 406 for performing the context-based functions described above, including but not limited to: deriving constructing a context (e.g., current conditions) of a driving environment by deriving contextual features from raw data; analyzing contextual features; constructing contextual feature maps; aggregating contextual features; contextual feature matching; determining a path for knowledge with specific contextual features. The knowledge cycle engine may be executed by processor 406 for performing knowledge cycle functions with contextual aspects, including but not limited to: executing stages of a knowledge cycle; inferring the contextual feature map of each step of knowledge cycle; triggering and/or executing knowledge refinement; and determine a path for knowledge with specific contextual features.

Processor 406 can include one or more GPUs, CPUs, microprocessors, or any other suitable processing system. Processor 406 may include a single core or multicore processors. The memory 408 may include one or more various forms of memory or data storage (e.g., flash, RAM, etc.) that may be used to store instructions and variables for processor 406 as well as any other suitable information, such as, one or more of the following elements: position data; vehicle speed data; risk and mitigation data, along with other data as needed. Memory 408 can be made up of one or more modules of one or more different types of memory, and may be configured to store data and other information as well as operational instructions that may be used by the processor 406 to vehicular knowledge networking circuit 410. For example, memory 408 may store instructions that, when executed by processor 406, perform functionality described in connection with FIG. 1 above.

Although the example of FIG. 4 is illustrated using processor and memory circuitry, as described below with reference to circuits disclosed herein, decision circuit 403 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a vehicular knowledge networking circuit 410.

Communication circuit 401 includes either or both a wireless transceiver circuit 402 with an associated antenna 414 and a wired I/O interface 404 with an associated hardwired data port (not illustrated). Communication circuit 401 can provide for vehicle-to-everything (V2X) and/or vehicle-to-vehicle (V2V) communications capabilities, allowing vehicular knowledge networking circuit 410 to communicate with edge devices, network cloud servers and cloud-based databases, and/or other vehicles via network 490. For example, V2X communication capabilities allows vehicular knowledge networking circuit 410 to communicate with edge/cloud servers, roadside infrastructure (e.g., such as roadside equipment/roadside unit, which may be a vehicle-to-infrastructure (V2I)-enabled street light or cameras, for example), etc. Vehicular knowledge networking circuit 410 may also communicate with other connected vehicles over vehicle-to-vehicle (V2V) communications.

As this example illustrates, communications with vehicular knowledge networking circuit 410 can include either or both wired and wireless communications circuits 401. Wireless transceiver circuit 402 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 414 is coupled to wireless transceiver circuit 402 and is used by wireless transceiver circuit 402 to transmit radio signals wirelessly to wireless equipment with which it is connected and to receive radio signals as well. These RF signals can include information of almost any sort that is sent or received by vehicular knowledge networking circuit 410 to/from other entities such as sensors 452 and vehicle systems 458.

Wired I/O interface 404 can include a transmitter and a receiver (not shown) for hardwired communications with other devices. For example, wired I/O interface 404 can provide a hardwired interface to other components, including sensors 452 and vehicle systems 458. Wired I/O interface 404 can communicate with other devices using Ethernet or any of a number of other wired communication protocols whether standardized, proprietary, open, point-to-point, networked or otherwise.

Power supply 412 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 452 can include, for example, sensors 352 such as those described above with reference to the example of FIG. 3. Sensors 452 can include additional sensors that may or may not otherwise be included on a standard vehicle with which the knowledge networking system 400 is implemented. In the illustrated example, sensors 452 include vehicle acceleration sensors 418, vehicle speed sensors 420, wheelspin sensors 416 (e.g., one for each wheel), accelerometers such as a 4-axis accelerometer 422 to detect roll, pitch and yaw of the vehicle, environmental sensors 428 (e.g., to detect salinity or other environmental conditions), and proximity sensor 430 (e.g., sonar, radar, lidar or other vehicle proximity sensors). Additional sensors 432 can also be included as may be appropriate for a given implementation of knowledge networking system 400.

System 400 may be equipped with one or more image sensors 460. These may include front facing image sensors, side facing image sensors, and/or rear facing image sensors. Image sensors may capture information which may be used in detecting not only vehicle conditions but also detecting conditions external to the vehicle as well. Image sensors that might be used to detect external conditions can include, for example, cameras or other image sensors configured to capture data in the form of sequential image frames forming a video in the visible spectrum, near infra-red (IR) spectrum, IR spectrum, ultra violet spectrum, etc. Image sensors 460 can be used to, for example, to detect objects in an environment surrounding a vehicle comprising knowledge networking system 400, for example, surrounding vehicles, roadway environment, road lanes, road curvature, obstacles, and so on. For example, a one or more image sensors 460 may capture images of surrounding vehicles in the surrounding environment. As another example, object detecting and recognition techniques may be used to detect objects and environmental conditions, such as, but not limited to, road conditions, surrounding vehicle behavior (e.g., driving behavior and the like), and the like. Additionally, sensors may estimate proximity between vehicles. For instance, the image sensors 460 may include cameras that may be used with and/or integrated with other proximity sensors 430 such as LIDAR sensors or any other sensors capable of capturing a distance. As used herein, a sensor set of a vehicle may refer to sensors 452.

Vehicle systems 458, for example, systems and subsystems 358 described above with reference to the example of FIG. 3, can include any of a number of different vehicle components or subsystems used to control or monitor various aspects of the vehicle and its performance. In this example, the vehicle systems 458 includes a vehicle positioning system 472; engine control circuits 476 to control the operation of engine (e.g. internal combustion engine 314 and/or motors 322); object detection system 478 to perform image processing such as object recognition and detection on images from image sensors 460, proximity estimation, for example, from image sensors 460 and/or proximity sensors, etc. for use in other vehicle systems; vehicle display and interaction system 474 (e.g., vehicle audio system for broadcasting notifications over one or more vehicle speakers), vehicle display system and/or the vehicle dashboard system), and other vehicle systems 482 (e.g., Advanced Driver-Assistance Systems (ADAS), autonomous or semi-autonomous driving systems 480, such as forward/rear collision detection and warning systems, pedestrian detection systems, autonomous or semi-autonomous driving systems, and the like).

Autonomous or semi-autonomous driving systems 480 can be operatively connected to the various vehicle systems 458 and/or individual components thereof. For example, autonomous or semi-autonomous driving systems 480 can send and/or receive information from the various vehicle systems 458 to control the movement, speed, maneuvering, heading, direction, etc. of the vehicle. The autonomous or semi-autonomous driving systems 480 may control some or all of these vehicle systems 458 and, thus, may be semi- or fully autonomous. In some examples, guidance, either knowledge-based guidance and/or compensation guidance, can be provided to autonomous or semi-autonomous driving systems 480 and used to control vehicle systems 458 and/or individual components thereof.

Network 490 may be a conventional type of network, wired or wireless, and may have numerous different configurations including a star configuration, token ring configuration, or other configurations. Furthermore, the network 490 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 490 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VOLTE, 5G-V2X or any other mobile data network or combination of mobile data networks. Further, the network 490 may include one or more IEEE 802.11 wireless networks.

In some embodiments, the network 490 includes a V2X network (e.g., a V2X wireless network). The V2X network is a communication network that enables entities such as elements of the operating environment to wirelessly communicate with one another via one or more of the following: Wi-Fi; cellular communication including 3G, 4G, LTE, 5G, etc.; Dedicated Short Range Communication (DSRC); millimeter wave communication; etc. As described herein, examples of V2X communications include, but are not limited to, one or more of the following: Dedicated Short Range Communication (DSRC) (including Basic Safety Messages (BSMs) and Personal Safety Messages (PSMs), among other types of DSRC communication); Long-Term Evolution (LTE); millimeter wave (mmWave) communication; 3G; 4G; 5G; LTE-V2X; 5G-V2X; LTE-Vehicle-to-Vehicle (LTE-V2V); LTE-Device-to-Device (LTE-D2D); Voice over LTE (VOLTE); etc. In some examples, the V2X communications can include V2V communications, Vehicle-to-Infrastructure (V2I) communications, Vehicle-to-Network (V2N) communications or any combination thereof.

Examples of a wireless message (e.g., a V2X wireless message) described herein include, but are not limited to, the following messages: a Dedicated Short Range Communication (DSRC) message; a Basic Safety Message (BSM); a Long-Term Evolution (LTE) message; an LTE-V2X message (e.g., an LTE-Vehicle-to-Vehicle (LTE-V2V) message, an LTE-Vehicle-to-Infrastructure (LTE-V2I) message, an LTE-V2N message, etc.); a 5G-V2X message; and a millimeter wave message, etc.

During operation, vehicular knowledge networking circuit 410 can receive information from various vehicle sensors to determine conditions of a driving environment, which can be used to construct contextual features, as described above in connection with FIGS. 1 and 2. Communication circuit 401 can be used to transmit and receive information between vehicular knowledge networking circuit 410 and sensors 452, and vehicular knowledge networking circuit 410 and vehicle systems 458. Also, sensors 452 may communicate with vehicle systems 458 directly or indirectly (e.g., via communication circuit 401 or otherwise).

In various embodiments, communication circuit 401 can be configured to exchange data and other information from edge or cloud serves vis client 405, which can be communicated to vehicle systems 458 for performing vehicle operations. For example, knowledge can be received from an edge server via communication circuit 401 and provided to machine learning model, stored in memory, to execute a knowledge-based guidance application via one or more subsystems 458. For example, autonomous or semi-autonomous driving systems 480 may comprise a machine learning model that controls vehicle operations according to knowledge received. In another example, knowledge and associated context (e.g., knowledge 145 of FIG. 1 and context 144 of FIG. 1) can be transmitted to an edge server via communication circuit 401 for use in context-based knowledge refinement as described above.

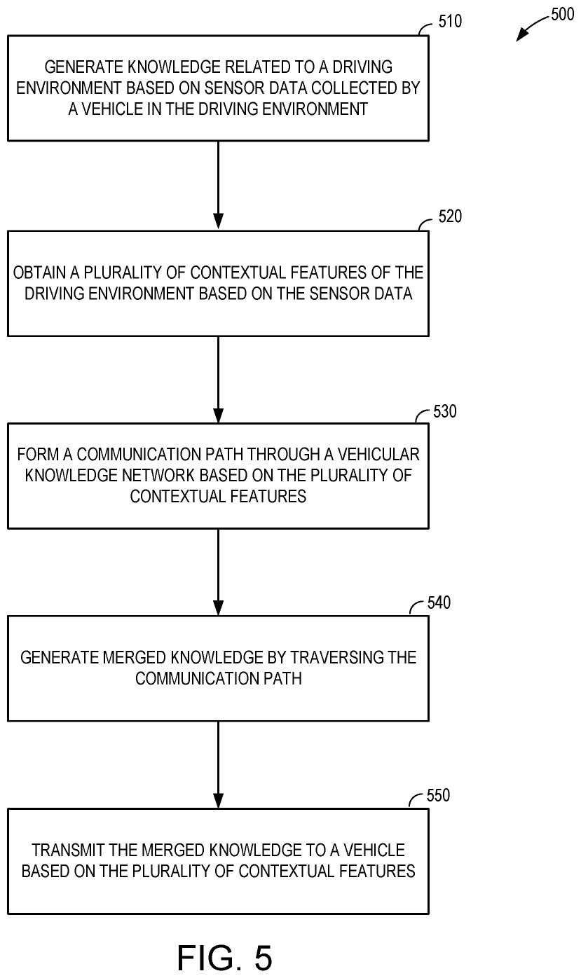

FIG. 5 is a flow chart illustrating example operations for context-based knowledge refinement in vehicular knowledge networking in accordance with embodiments disclosed herein. Process 500 may be implemented as instructions, for example, stored on in memory, that when executed by one or more processors perform one or more operations of process 500. In one example, process 500 may be implemented as instructions stored on vehicular knowledge networking circuit 410, that when executed by one or more processors, perform one or more operations of process 500. In another example, one or more operations of process 500 may be performed by an edge server, such as one or more of computer systems 130a-130e of FIG. 1. Furthermore, one or more operations of process 500 can be executed by vehicular knowledge networking circuit 410, while other operations are performed by one or more of computer systems 130a-130e.

At operation 510, knowledge related to a driving environment can be generated based on sensor data and information collected and processed by a vehicle in the driving environment. For example, while a vehicle (e.g., vehicle 110 of FIG. 1) is traveling in the driving environment, sensor data can be collected by sensors installed on the vehicle and/or data may be received by other entities in the driving environment (e.g., other vehicles, RSE, etc.). The sensor data can analyzed in accordance with various knowledge creation techniques to transform the data into knowledge (e.g., knowledge 145 of FIG. 1) that provides meaningful information of the driving environment. For example, knowledge creation can be performed by known data analysis technique, such as, but not limited to, formal language techniques, model-based approaches, deep learning-based methods, and the like, as described above in connection with FIG. 1.

At operation 520, a plurality of contextual features of the driving environment can be obtained based on the sensor data. For example, as described above in connection with FIG. 1, the sensor data used to generate knowledge at operation 510 can be processed in accordance with the disclosed vehicular knowledge networking capabilities to provide contextual features (e.g., contextual features 146a-146e) which constitute a context (e.g., context 144) that corresponds to the knowledge generated at operation 510. Multiple pieces of sensor data can be used to infer inner relationships or repeating patterns and contextual relevance that may be found in data, thereby extracting insight on this data that can serve as the knowledge and context (e.g., the contextual features). For example, the vehicle may have the capabilities to create contextual features maps for the driving environment in which vehicle travels, and extract meaningful contextual information that enables creation of context in the form of the contextual features associated with the knowledge, as described above in connection with FIG. 1.

The plurality of contextual features may represent various conditions of the driving environment in which the vehicle is traveling. For example, the vehicle may leverage vehicle data descriptive of the conditions experienced at the time while driving through the environment (e.g., at the time the raw data used to generate the knowledge of operation 510 is collected), such as traffic flow, vehicle/driver type, congestion, type of objects at the location, risk caused by other drivers, weather conditions, and the like. This vehicle data, representative of the contextual features, can be provided as the context associated with the knowledge, as described above in connection with FIG. 1. Contextual features can be derived from the raw data by executing known time series analysis techniques on the raw sensor data.

The contextual features inferred at operation 520 can comprise static and/or dynamic properties of the driving environment. Static properties include, but are not limited to, a location, road geometry, traffic rules, and the like. Dynamic properties can include, but are not limited to, traffic flow, vehicle/driver type, congestion, type of objects at the location, risk caused by other drivers, weather, etc.

While FIG. 5 depicts operation 520 as following operation 510, embodiments disclosed herein are not limited to the depicted order of operation. For example, operation 520 may be executed prior to or concurrently with operation 510, as described above in connection with FIG. 1.

At operation 530, a communication path through a vehicular knowledge network can be formed based on the plurality of contextual features. For example, a vehicular knowledge network may comprise a plurality of vehicular knowledge networking nodes (e.g., computer systems 130a-130e of FIG. 1). The vehicular knowledge networking nodes may each store a respective node knowledge (e.g., node knowledge 135, 134c, and 135e) and corresponding node context (e.g., node context 136a, 136c, and 136e) in memory. As described above in connection with FIG. 1, the node context of each vehicular knowledge networking node can be analyzed to determine whether or not each respective node context includes a subset (e.g., one or more) of the contextual features inferred at operation 520. A communication path (e.g., communication path 142) can be established that includes each of identified vehicular knowledge networking nodes in a sequential order. For example, the communication path may be formed from vehicle through the identified vehicular knowledge networking nodes, such that the communication path traverse vehicular knowledge networking nodes that collectively cover all of contextual features inferred at operation 520.

According to embodiments, operation 530 can be executing by utilizing various methods and/or techniques. For example, operation 530 can be performed by utilizing known graph analysis and cycle detection algorithms, such as bread-first search algorithms, to identify vehicular knowledge networking nodes and form paths (also referred to as cycles) that collectively cover all of the contextual features inferred at operation 520. In some examples, an initial path can be identified using a random approach in which each vehicular knowledge networking node is selected at random until each contextual feature is covered by a vehicular knowledge networking node.

Operation 530 may comprise a determination that knowledge generated at operation 510 is does not satisfy a knowledge refinement criteria. For example, the knowledge may have a performance metric, such as, but not limited to, accuracy, benefit (e.g., utilization), diversity, lifetime, and/or quantification (e.g., amount) of raw data used to generate the knowledge. If the performance metric is below a set threshold, the knowledge may not satisfy the performance criteria and operation 530 may trigger formation of the communication path 142. For example, if the performance metric, in terms of an amount of raw data or diversity in data distribution is below a set threshold, operation 530 may trigger formation of the communication path 142. In another example, if the performance metric, in terms of accuracy, exhibits performance degradation (e.g., decrease in performance achieved by knowledge based-guidance), operation 530 may trigger formation of communication path 142. Performance degradation may be detected by monitoring performance of the knowledge-based guidance generated from the knowledge over time and comparing current performance to preceding performance. Where the current performance decreases below a preceding performance, performance degradation may be detected.

In various examples, triggering the formation of the communication path 142 may comprise providing a query to a vehicular knowledge networking node of the vehicular knowledge network for context-based knowledge refinement. In an example, the vehicle may transmit a query to a closest vehicular knowledge networking node. In another example, the vehicle may query a random vehicular knowledge networking node. In yet another example, the vehicle may exchange messages with vehicular knowledge networking nodes to identify a vehicular knowledge networking node having a context comprising at least one of the inferred contextual features. The query may comprise the knowledge generated at operation 510 and the contextual features inferred at operation 520.

In an example, operation 530 may be executed by the vehicle. In this case, the vehicle may trigger context-based knowledge refinement by querying vehicular knowledge networking nodes of the vehicular knowledge network for a vehicular knowledge networking nodes having knowledge associated with at least one of contextual features inferred at operation 520. In another example, the vehicular knowledge network can be searched by one or more vehicular knowledge networking nodes based on the query from the vehicle to locate one more vehicular knowledge networking nodes that collectively cover the contextual features inferred at operation 520 prior to vehicle sending the knowledge generated at operation 510.

At operation 540, merged knowledge can be generated by traversing the communication path formed at operation 530. For example, as described above, the communication path may comprise a plurality of vehicular knowledge networking nodes identified based on the contextual features inferred at operation 520. The knowledge generated at operation 510 can be combined with the node knowledge of the vehicular knowledge networking nodes to generate merged knowledge through knowledge composition techniques.

In various examples, the knowledge generated at operation 510 can be successively combined with node knowledge of each vehicular knowledge networking node by traversing the communication path according to the sequential order. That is, for example, the sequential order may define an order in which the vehicular knowledge networking nodes are to be traversed along the communication path. The knowledge generated at operation 510 can be combined with knowledge of a first vehicular knowledge networking node along the communication path to generate first intermediate-merged knowledge. The first intermediate-merged knowledge can be combined with the node knowledge of the next vehicular knowledge networking node to generate a next intermediate-merged knowledge. The process repeats at each vehicular knowledge networking node along the communication path to successively execute knowledge composition using its knowledge and a preceding intermediate-merged knowledge to ultimately generate merged knowledge (e.g., merged knowledge 147).

At operation 550, the merged knowledge can be transmitted to a vehicle based on the plurality of contextual features inferred at operation 520. As described above in connection with FIG. 1, the merged knowledge can be used to generate knowledge-based guidance. Operation 550 may comprise executing context-based knowledge forwarding, as described in connection with FIG. 1, such that the “correct” knowledge is provided for the corresponding driving environment based on a match (e.g., substantially similar or identical) between current conditions and the context associated with the merged knowledge, which is made up of the contextual features inferred at operation 520. The vehicle at operation 550 may be the same vehicle as that in operations 510 and 520 or a different vehicle.

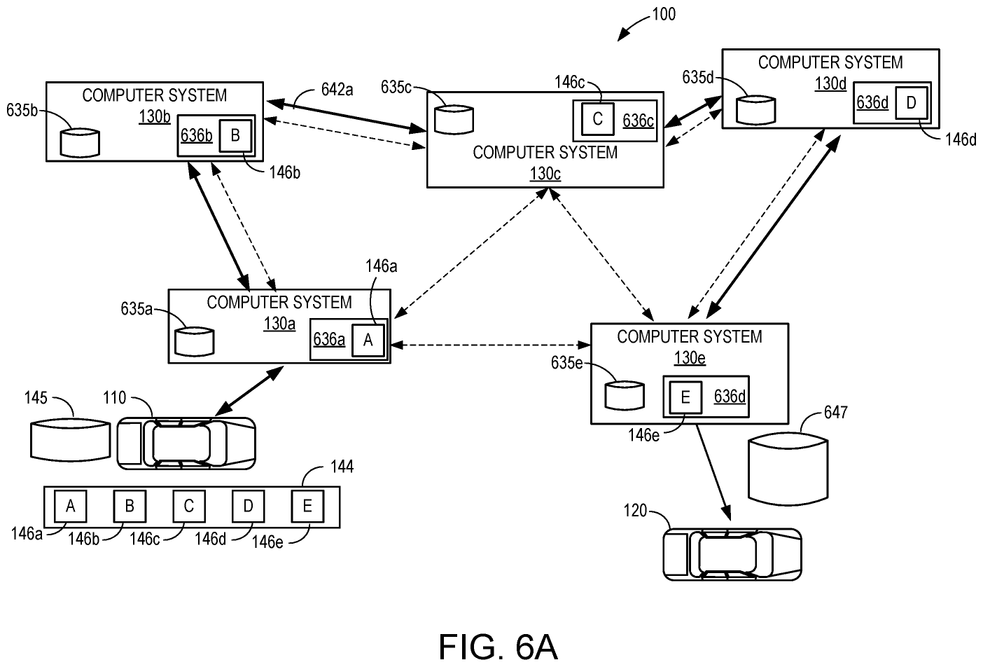

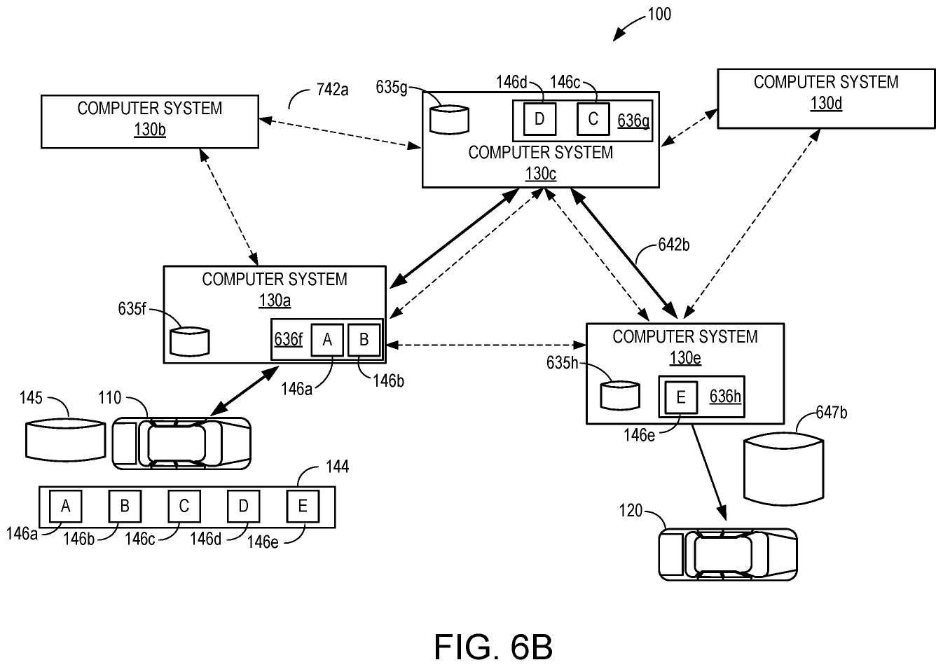

The vehicular knowledge network may comprise a number of different communication paths, each of which connect different arrangements of vehicular knowledge networking nodes to collectively cover all of the inferred contextual features. FIGS. 6A and 6B depict examples of two different communication paths 642a and 642b that can be formed through the vehicular knowledge network system 100 in accordance with embodiments disclosed herein. For example, vehicular knowledge network system 100 may comprise communication path 142, as described above in connection with FIG. 1, as well as communication paths 642a and 642b, each of which comprise a set of computer systems that collective comprise contextual features 146a-146e.

In examples, each computer system 130a-130e may store one or more instances of node knowledge and associated node context. For example, computer system 130a may store node knowledge 135a, as described in connection with FIG. 1, as well as node knowledge 635a shown in FIG. 6A and node knowledge 635f shown in FIG. 6B. Node knowledge 635a and 635f may be associated with node context 636a and 636f, respectively. Similarly, computer system 130b may store node knowledge 635b and associated node context 636b, as well as other node knowledge and node context; computer system 130c may store node knowledge 135c, 635c, and 635g and associated node context 136c, 636c, and 636g, respectively; computer system 130d may store node knowledge 635d and associated node context 636d, as well as other node knowledge and node context; and computer system 130e may store node knowledge 635e and associated node context 636e, which may be the same or different than the node knowledge 135a and node context 136e also stored in computer system 130e.

As described above, the context of each computer system 130a-130e can be analyzed to determine whether or not the respective node context includes a subset of the contextual features 146a-146e. In one case as shown in FIG. 1, a communication path 142 can be established from vehicle 110 through the computer systems 130a-130e, such that the communication path 142 comprises computer systems 130a, 130c, and 130e that collectively cover all of contextual features 146a-146e. Thus, merged knowledge 147 can be generating by traversing the communication path 142 as described above in connection with FIG. 1.

In another case, as shown in FIG. 6A, a communication path 642a can be established from vehicle 110 through computer systems 130a-130e, such that the communication path 642a comprises computer systems 130a-130e to collectively cover each of contextual features 146a-146e. In this case, node context 636a comprises contextual feature 146a, node context 636b comprises contextual feature 146b, node context 636c comprises contextual feature 146c, node context 636d comprises contextual feature 146d, and node context 636e comprises contextual feature 146e. Similar to the knowledge composition described in connection with FIG. 1, merged knowledge 647a can be generated by traversing the communication path 642a and successively executing knowledge composition at each computer system 130a-130e to combine node knowledge and/or intermediate-merged knowledge along the communication path 642a.

In another case, as shown in FIG. 6B, a communication path 642b can be established from vehicle 110 through computer systems 130a, 130c, and 130e, such that the communication path 642b comprises computer systems 130a, 130c, and 130e to collectively cover each of contextual features 146a-146e. In this case, node context 636f comprises contextual features 146a and 146b, node context 636g comprises contextual features 146c and 146d, and node context 636h comprises contextual feature 146e. Similar to the knowledge composition described in connection with FIG. 1, merged knowledge 647b can be generated by traversing the communication path 642b and successively executing knowledge composition at each computer system 130a, 130c, and 130e to combine node knowledge and/or intermediate-merged knowledge along the communication path 642a.

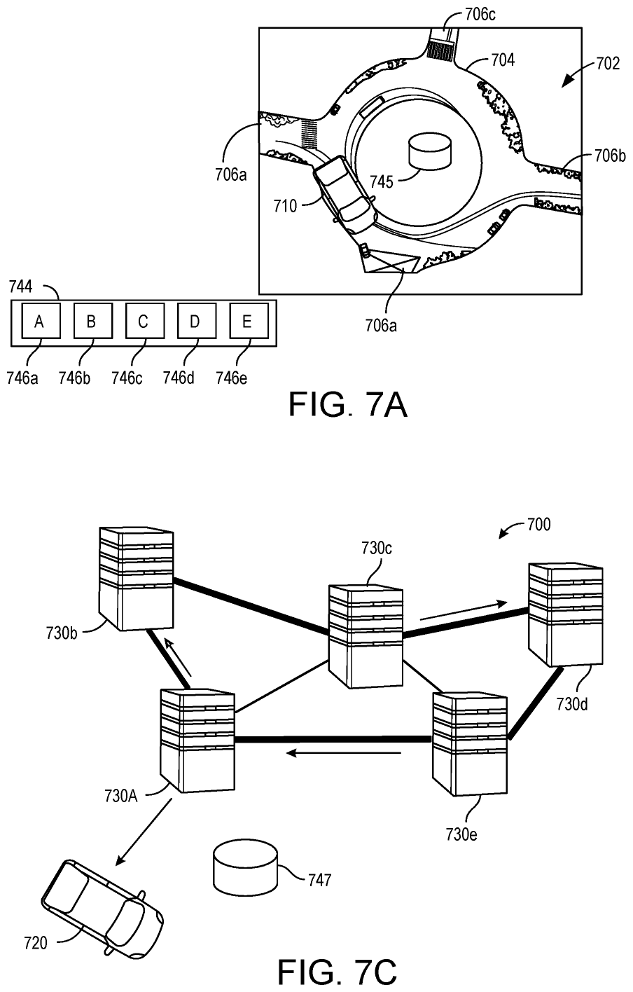

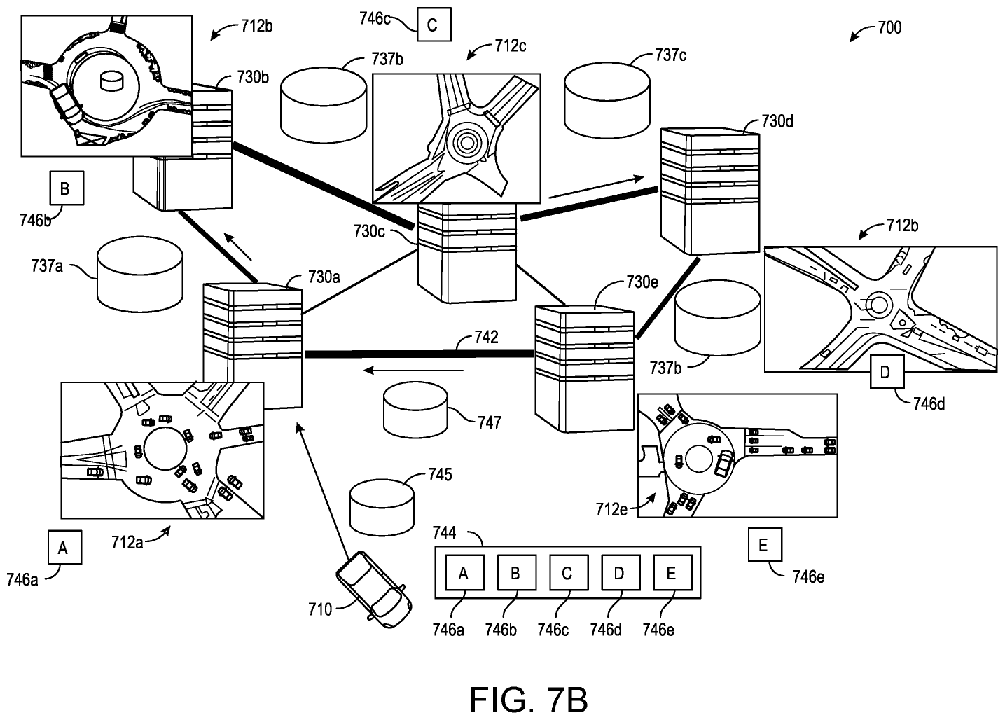

FIGS. 7A-7C depict an example illustration of a use case of embodiments disclosed herein including context-based knowledge refinement. FIGS. 7A-7C illustrate a scenario in which context-based knowledge refinement can be leveraged to improve performance of knowledge for a driving environment 702.

In the example of FIG. 7A, driving environment 702 is shown comprising a roundabout 704. A vehicle 710 may generate knowledge 745 based on sensor data collected by the vehicle 710 while traveling in driving environment 702. Vehicle 710 may be substantially similar to vehicle 110 and may comprise a vehicular knowledge networking circuit 410 of FIG. 4, which may execute a knowledge cycle to create knowledge in a manner described above in connection with FIGS. 1 and operation 510 of FIG. 5. Knowledge 745 may be an example of knowledge 145 of FIG. 1. In this example, knowledge 745 may provide exit probabilities of the roundabout 704. That is, for example, knowledge 745 may estimate probabilities that vehicle 710 exits the roundabout 704 from each roadway 706a-706d. Thus, each roadway 706a-706d can be assigned a probability that vehicle 710 uses the respective roadway to exit the roundabout 704. Knowledge-based guidance may leverage the assigned exit probability to control the vehicle so to exit the roundabout from the roadway having the highest probability.

Vehicle 710 may also derive a context 744 for knowledge 745 in a manner described above in connection with FIGS. 1 and operation 520 of FIG. 5. The context 744 comprises contextual features 746a-746e inferred from the sensor data collected by vehicle 710 while traveling in the driving environment 702. As an illustrative example, contextual feature 746a may indicate traffic rules for driving in the roundabout 704 of driving environment 702, contextual feature 746b may indicate a geometry of roundabout 704, contextual feature 746c may indicate a number of roadways that input/exit from the roundabout 704, contextual feature 746d may indicate traffic congestion of the driving environment 702, and contextual feature 746e may indicate weather of the driving environment 702. Other contextual features may be included depending on the driving environment.

In examples, knowledge 745 may be used by vehicle 710 for knowledge-based guidance. For example, knowledge 745 may assign exit probabilities to each roadway 706a-706b and generate guidance to control the vehicle 710 so to exit the roundabout from the roadway having the highest probability. However, knowledge 745 may be generated from a limited amount or a limited type of raw data (e.g., sensor data). For example, knowledge 745 may be generated from observations from a single vehicle, such as only sensor data from vehicle 710. Thus, knowledge 745 from may be limited in benefit, for example, in terms of accuracy, which may translate in less optimal guidance. In some cases, the limited benefit could result in increased exposure to risk due to unreliable or inaccurate knowledge (e.g., knowledge 745 may select an improper roadway as the exit).

Thus, embodiment disclosed herein can execute context-based knowledge refinement as described herein to improve benefits of knowledge 745 by combining knowledge 745 with other knowledge according to contextual features and delivering merged knowledge to a vehicle. For example, FIG. 7B illustrates a vehicular knowledge network 700 comprising a number of vehicular knowledge networking nodes, illustratively depicted as vehicle 710 and remote servers 730a-730e, which are example implementations of computer systems 130a-130e of FIG. 1. Operation 530 of FIG. 5 may be executed, for example by one or more of vehicle 710 and remote servers 730a-730e, to form a communication path 742 through the vehicular knowledge network 700 based on the contextual features 746a-746e inferred by vehicle 710. As described above, forming the communication path 742 may include identifying remote servers 730a-730e having node context that collectively covers each of contextual features 746a-746e.

In the example of FIG. 7B, communication path 746 is established that comprises each of remote servers 730a-730e. In this example, each remote server 730a-730e stores node knowledge (not shown in FIG. 7B) associated with a node context representative of conditions of a respective driving environment 712a-712e. The node context at each remote server 730a-730e can be examined to locate node context that comprise one or more of contextual features 746a-746e. In the example of FIG. 7B, driving environment 712a may have the same traffic rules as driving environment 702. Thus, remote server 730a stores a context that comprises contextual features including contextual feature 746a. Driving environment 712b may have the same geometry as driving environment 702, and as such remote server 730b stores a context including contextual feature 746b. Driving environment 712c may have the same number of roadways exiting from a roundabout as driving environment 702, and as such remote server 730c stores a context including contextual feature 746c. Driving environment 712d may have the same traffic congestion as the driving environment 702, and as such remote server 730d stores a context including contextual feature 746d. Driving environment 712e may have the same weather as the driving environment 702, and as such remote server 730e stores a context including contextual feature 746e. Thus, each remote server 730a-730e comprises at least one of contextual features 746a-746e.

The vehicle 710 may then provide the knowledge 745 to the vehicular knowledge network, and the communication path 742 can be traversed to generate merged knowledge 747. For example, as described above in connection with FIG. 1 and operation 540 of FIG. 5, the communication path 742 may be traversed in a sequential order and knowledge composition techniques executed at each node of the communication path. In the example of FIG. 7B, remote server 730a receives knowledge 745 from vehicle 710 and executes knowledge composition to combine its node knowledge with knowledge 745 to generate intermediate-merged knowledge 737a. Remote server 730a then transmits this intermediate-merged knowledge 737a to remote server 730b, which combines the intermediate-merged knowledge 737a with its node knowledge to generate intermediate-merged knowledge 737b. The process repeats at each remote server along the communication path 742 to successively generate intermediate merged knowledge 737c and 737d until the remote server 730d ultimately generates merged knowledge 747. In the example of FIG. 7B, the merged knowledge 747 is provided to the remote server 730a, but in other examples the merged knowledge need not be transmitted.

FIG. 7C illustrates an example in which merged knowledge 747 is provided to a vehicle 720 through context-based knowledge forwarding techniques as described above (e.g., in connection with FIG. 1 and operation 550 of FIG. 5). Vehicle 720 may be driving in the roundabout 704 of FIG. 7A and infer current conditions of the driving environment in which vehicle 720 is operating. Using the inferred conditions, vehicle 720 may request knowledge from the vehicular knowledge network. If a match is determined between the inferred conditions and the context associated with the merged knowledge 747, the merged knowledge can be provided to vehicle 720, which can execute knowledge-based guidance applications (such as safety maneuvers) as using the merged knowledge 147 to operate the vehicle to safely maneuver through the roundabout 704.

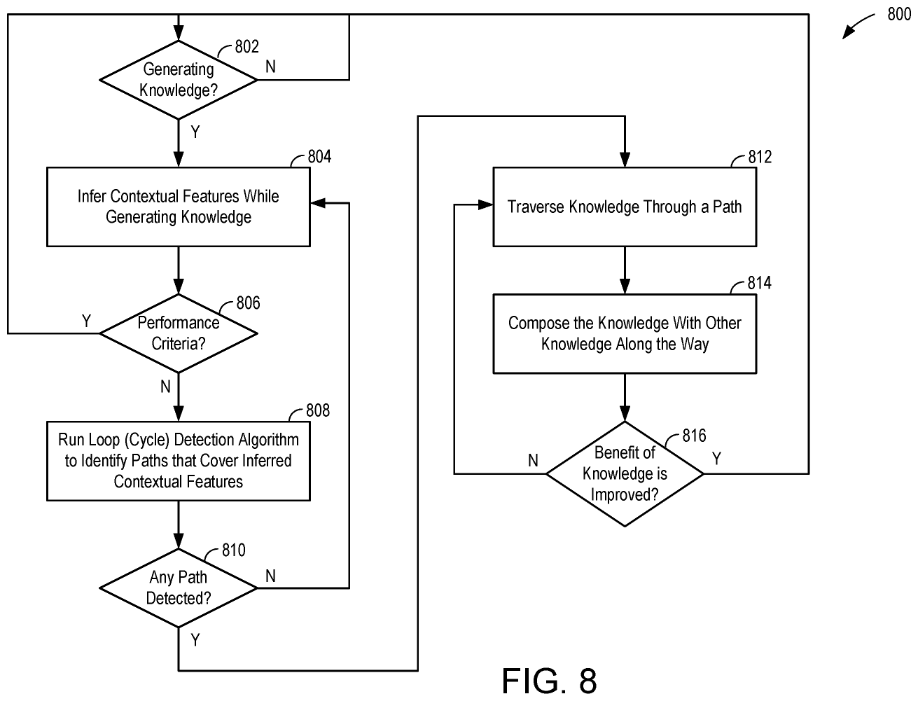

FIG. 8 is a flow chart illustrating an example process of context-based knowledge refinement in accordance with embodiments disclosed herein. Process 800 may be implemented as instructions, for example, stored on in memory, that when executed by one or more processors perform one or more operations of process 800. In one example, process 800 may be implemented as instructions stored on vehicular knowledge networking circuit 410, that when executed by one or more processors, perform one or more operations of process 800. In another example, one or more operations of process 800 may be performed by an edge server, such as one or more of computer systems 130a-130e of FIG. 1. Furthermore, one or more operations of process 800 can be executed by vehicular knowledge networking circuit 410, while other operations are performed by one or more of computer systems 130a-130e.

At determination block 802, a determination is made on whether knowledge is generated or not. For example, a vehicle (e.g., vehicle 110) may collected raw data and generate knowledge, as described above in connection with FIGS. 1, 5, and 6A-7. If knowledge is not being generated the process 600 repeats knowledge is generated.

At block 804, based on (e.g., in response to) a determination that knowledge was generated, contextual features can be inferred for the knowledge and associated therewith. For example, as described above in connection with FIGS. 1, 5, and 6A-7, contextual features may be inferred from the raw data used to generate the knowledge. Contextual features may represent conditions, such as static and/or dynamic properties, of the driving environment in which the vehicle is traveling.

At determination block 806, a determination is on whether the knowledge satisfies a knowledge refinement criteria. For example, the knowledge may have a performance metric, such as accuracy and/or quantification (e.g., amount and/or diversity) of raw data used to generate the knowledge. If the performance metric satisfies the knowledge refinement criteria, process 800 returns to block 802. If the performance metric does not satisfy the knowledge refinement criteria, process 800 triggers block 808. Examples of the knowledge refinement criteria are provided above in connection with FIG. 5.

At block 808, one or more communication paths are identified in a vehicular knowledge network by running a cycle or loop detection algorithm based on contextual features inferred at block 804. As described above in connection with FIGS. 1, and 5-7C, the vehicular knowledge network (e.g., vehicular knowledge network system 100) comprises a plurality of vehicular knowledge networking nodes (e.g., computer systems 130a-130e) that store node knowledge and associated node context. Block 808 may examine the node context at each vehicular knowledge networking node to locate node context comprising a subset (e.g., one or more) of the contextual features inferred at block 804 and identify respective vehicular knowledge networking nodes. The cycle detection algorithm can then analyze the identified vehicular knowledge networking nodes to identify one or more communication paths (e.g., communication paths 142, 642a, and/or 642b) through the vehicular knowledge network that collectively cover each of the inferred contextual features. The identified communication paths may be further constrained to cover a single instance of each inferred contextual feature. That is, for example, each contextual feature is covered only once along the path and no duplication of contextual features occurs along a given communication path).

At determination block 810, a determination is made on whether any communication paths are detected at block 808. If no communication paths are detected, process 800 returns to block 804 (e.g., a feedback to block 804) and repeats the process. In some cases, repeating block 804 may infer different contextual features for the same driving environment due to changes in the raw data over time. Thus, repeating blocks 804-808 may discover communication paths through the network that were missed during a prior instance. If one or more communication paths are detected, process 800 proceeds to block 812.

At blocks 812 and 814, a communication path is traversed and knowledge is composed the other knowledge along the way. For example, as described above in connection with FIGS. 1 and 5-7C, each communication path may include a sequential order of traversing the vehicular knowledge networking nodes that make up the path. Knowledge can be transferred from one entity to the next according to the sequential order, and received knowledge combined with knowledge of each entity through knowledge composition techniques, as described above. For example, the vehicle that generated knowledge at block 802 can provide the knowledge to a first vehicular knowledge networking node along the communication path, which combines the knowledge with its node knowledge to generate intermediate-merged knowledge. The intermediate-merged knowledge can be combined with node knowledge of the next vehicular knowledge networking node along the communication path to generate a subsequent intermediate-merged knowledge. The process repeats at each vehicular knowledge networking node along the communication path, which successively executes knowledge composition using its knowledge and a preceding intermediate-merged knowledge to ultimately generate merged knowledge.

At determination block 816, the benefit of the merged knowledge is evaluated and a determination is made as to whether or not the benefit has improved. Benefits of knowledge can be evaluated in terms of accuracy of the knowledge. The accuracy can be determined by applying the knowledge to a trained machine learn model that generates knowledge-based guidance and the accuracy of the guidance can be evaluated by applying the guidance to test data or by evaluating actual real-world application of the knowledge-based guidance. In some examples, benefit could be represented as a number of agents (e.g., vehicles) using the merged knowledge. Embodiments disclosed herein may count the agents that utilize the merged knowledge and measure the performance (e.g., accuracy, diversity, lifetime, etc.).

In some examples, a threshold may be set (e.g., 80% accurate) and if the benefit does not meet or exceed this threshold, the determination at determination block 816 may be negative. In some examples, the threshold may be threshold number of agents that utilize the knowledge (e.g., utilization or benefit). In another example, As another example, the benefit determined at determination block 816 may be provided as a measured value of entropy and thresholding performed in terms of data diversity represented by entropy. Consequently, process 800 can return to block 812 and another communication path of the one or more communication paths detected at block 808 can be traversed as described above. The benefit of this iteration of blocks 812 and 814 can be evaluated and feedback loop repeated until the benefit of the merged knowledge meets or exceeds the threshold. Once the determination at determination block 816 is affirmative (either on a first or later iteration), process 800 returns to determination block 802.

In another example, the threshold at determination block 816 may be based on a preceding iteration of block 812 and 814. That is, in some examples, the benefit of knowledge generated by a current iteration of block 814 can be compared to a benefit of previous iteration of block 814. If the benefit of the current iteration is greater than that of the preceding iteration, the determination at determination block 816 may be affirmative. Otherwise, process 800 may return to block 812 to execute a next iteration. In the case of an initial iteration, the determination at determination block 816 may be negative as there is not preceding iteration for comparison yet. In some examples, the threshold at determination block 816 may comprise both a threshold benefit (e.g., 80%) and that the current iteration is greater than the preceding iteration.

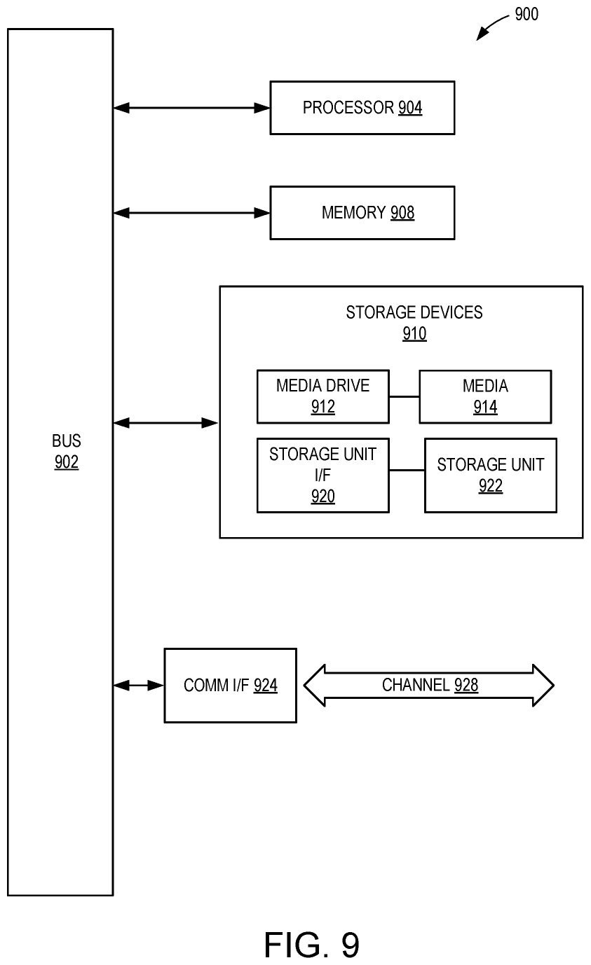

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 9. Various embodiments are described in terms of this example-computing component 900. After reading this description, it will become apparent to a person skilled in the relevant art how to implement the application using other computing components or architectures.

Referring now to FIG. 9, computing component 900 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 900 might also represent computing capabilities embedded within or otherwise available to a given device. For example, a computing component might be found in other electronic devices such as, for example, portable computing devices, and other electronic devices that might include some form of processing capability.

Computing component 900 might include, for example, one or more processors, controllers, control components, or other processing devices. This can include a processor, and/or any one or more of the components making up system 100 of FIG. 1 and/or remote servers 730a-730e of FIG. 7. Processor 904 might be implemented using a general-purpose or special-purpose processing engine such as, for example, a microprocessor, controller, or other control logic. Processor 904 may be connected to a bus 902. However, any communication medium can be used to facilitate interaction with other components of computing component 900 or to communicate externally.

Computing component 900 might also include one or more memory components, simply referred to herein as main memory 908. For example, random access memory (RAM) or other dynamic memory, might be used for storing information and instructions to be executed by processor 904. Main memory 908 may be configured to store instructions, that when executed by processor 904, perform the operations described in connection with FIGS. 5 and 8. Main memory 908 might also be used for storing temporary variables or other intermediate information during execution of instructions to be executed by processor 904. Computing component 900 might likewise include a read only memory (“ROM”) or other static storage device coupled to bus 902 for storing static information and instructions for processor 904.

The computing component 900 might also include one or more various forms of information storage mechanism 910, which might include, for example, a media drive 912 and a storage unit interface 920. The media drive 912 might include a drive or other mechanism to support fixed or removable storage media 914. For example, a hard disk drive, a solid-state drive, a magnetic tape drive, an optical drive, a compact disc (CD) or digital video disc (DVD) drive (R or RW), or other removable or fixed media drive might be provided. Storage media 914 might include, for example, a hard disk, an integrated circuit assembly, magnetic tape, cartridge, optical disk, a CD or DVD. Storage media 914 may be any other fixed or removable medium that is read by, written to or accessed by media drive 912. As these examples illustrate, the storage media 914 can include a computer usable storage medium having stored therein computer software or data.

In alternative embodiments, information storage mechanism 910 might include other similar instrumentalities for allowing computer programs or other instructions or data to be loaded into computing component 900. Such instrumentalities might include, for example, a fixed or removable storage unit 922 and an interface 920. Examples of such storage units 922 and interfaces 920 can include a program cartridge and cartridge interface, a removable memory (for example, a flash memory or other removable memory component) and memory slot. Other examples may include a PCMCIA slot and card, and other fixed or removable storage units 922 and interfaces 920 that allow software and data to be transferred from storage unit 922 to computing component 900.

Computing component 900 might also include a communications interface 924. Communications interface 924 might be used to allow software and data to be transferred between computing component 900 and external devices. Examples of communications interface 924 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 924 may be carried on signals, which can be electronic, electromagnetic (which includes optical) or other signals capable of being exchanged by a given communications interface 924. These signals might be provided to communications interface 924 via a channel 928. Channel 928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 908, storage unit 922, media 914, and channel 928. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 900 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
obtaining a plurality of contextual features of a driving environment based on knowledge related to the driving environment obtained using sensor data collected by a first vehicle in the driving environment;
identifying a plurality of nodes of a vehicular knowledge network based on the plurality of contextual features, wherein each of the plurality of nodes comprises node knowledge associated with a respective subset of the plurality of contextual features;
generating merged knowledge by combining the first knowledge with the node knowledge of at least one of the plurality of nodes; and
transmitting the merged knowledge to a second vehicle, wherein the second vehicle performs a vehicular operation based on the merged knowledge.

2. The method of claim 1, wherein generating merged knowledge by combining the first knowledge with the node knowledge of at least one of the plurality of nodes comprises:
generating merged knowledge by combining the first knowledge with the node knowledge of each of the plurality of nodes.

3. The method of claim 1, wherein the plurality of contextual features comprises at least one of static properties and dynamic properties obtained from the driving environment.

4. The method of claim 1, wherein inferring the plurality of contextual features comprises:
executing time series analysis on the sensor data to derive the plurality of contextual features.

5. The method of claim 1, wherein the plurality of nodes of the vehicular knowledge network collectively comprise the plurality of contextual features.

6. The method of claim 1, wherein identifying a plurality of nodes of a vehicular knowledge network comprises:
identifying a path through the vehicular knowledge network that traverses the plurality of nodes.

7. The method of claim 6, wherein generating the merged knowledge by combining the first knowledge with the node knowledge of each of the plurality of nodes comprises:
successively combining the first knowledge with each node of the plurality of nodes while traversing the path through the vehicular knowledge network.

8. The method of claim 1, wherein generating the merged knowledge by combining the first knowledge with the node knowledge of each of the plurality of nodes comprises:
aggregating the first knowledge with node knowledge of a first node of the plurality of nodes to generate first intermediate-merged knowledge; and
aggregating the first intermediate-merged knowledge with node knowledge of a second node of the plurality of nodes to generate second intermediate-merged knowledge.

9. The method of claim 1, further comprising:
detecting a knowledge refinement criteria,
wherein identifying the plurality of nodes of the vehicular knowledge network is based on detecting the knowledge refinement criteria.

10. The method of claim 9, wherein the knowledge refinement criteria comprises one of a performance degradation in the first knowledge and an amount of sensor data used to generate the first knowledge being less than a threshold amount.

11. A vehicle comprising:
a memory storing instructions; and
one or more processors communicably coupled to the memory and configured to execute the instructions to:
derive a plurality of contextual features of a driving environment based on sensor data collected by a first vehicle in the driving environment, the plurality of contextual features are associated with first knowledge related to the driving environment;
establish a communication path through a vehicular knowledge network based on the plurality of contextual features, wherein the path comprises a plurality of nodes, and wherein at least one of the plurality of nodes comprises node knowledge associated with at least one of the plurality of contextual features; and
receive merged knowledge based on combining the first knowledge with the knowledge of each of the plurality of nodes,
wherein vehicular operations are performed based on the merged knowledge.

12. The vehicle of claim 11, wherein the plurality of contextual features comprises at least one of static properties and dynamic properties obtained from the driving environment.

13. The vehicle of claim 11, wherein deriving the plurality of contextual features comprises:
executing time series analysis on the sensor data to derive the plurality of contextual features.

14. The vehicle of claim 11, wherein the plurality of nodes of the vehicular knowledge network collectively comprise the plurality of contextual features.

15. The vehicle of claim 11, wherein establish the communication path through the vehicular knowledge network comprises:
identifying the plurality of nodes based on the plurality of contextual features.

16. The vehicle of claim 11, wherein the one or more processors are further configured to execute the instructions to:
transmit the first knowledge to a first node of the plurality of nodes based on at least one of the plurality of contextual features.

17. The vehicle of claim 11, wherein the one or more processors are further configured to execute the instructions to:
detect a knowledge refinement criteria,
wherein establishing the communication path through the vehicular knowledge network is based on detecting the knowledge refinement criteria.

18. The vehicle of claim 17, wherein the knowledge refinement criteria comprises one of a performance degradation in the first knowledge and an amount of sensor data used to generate the first knowledge being less than a threshold amount.

19. A system comprising:
a memory storing instructions; and
one or more processors communicably coupled to the memory and configured to execute the instructions to:
receive, from a vehicle, a plurality of contextual features associated with knowledge related to a driving environment based on sensor data of the vehicle collected from the driving environment;
execute cycle detection to identify a communication path through a plurality of nodes of vehicular knowledge network, wherein each of the plurality of nodes comprises at least a contextual feature of the plurality of contextual features, and wherein the plurality of nodes collectively comprise the plurality of contextual features; and
execute knowledge composition to generate merged knowledge by aggregating node knowledge of the plurality of nodes with the knowledge.

20. The system of claim 19, wherein the one or more processors are further configured to execute the instructions to:
execute knowledge creation based on raw data obtained from one or more connected vehicles, the knowledge creation comprising generating node knowledge and deriving a context of associated with the knowledge.
